(19) United States
(12) Patent Application Publication
(10) Pub. No.: US 2021/0382757 A1
(43) Pub. Date: Dec. 9, 2021

(54) RESOURCE MANAGEMENT APPARATUS AND RECORDING MEDIUM RECORDING RESOURCE MANAGEMENT PROGRAM

(71) Applicant: FUJITSU LIMITED, Kawasaki-shi (JP)

(72) Inventors: Yuzuru Azuma, Kawasaki (JP); Kensuke Shinozaki, Mishima (JP); Takashi Nakayama, Numazu (JP)

(73) Assignee: FUJITSU LIMITED, Kawasaki-shi (JP)

(21) Appl. No.: 17/209,284

(22) Filed: Mar. 23, 2021

(30) Foreign Application Priority Data
Jun. 8, 2020 (JP) 2020-099480

(51) Int. Cl. G06F 9/50

(52) U.S. Cl. CPC G06F 9/5027

(57) ABSTRACT

A resource management apparatus for adding an arithmetic operation resource to each of a plurality of unit periods included in an execution period for executing a job, the resource management apparatus includes: a memory; and a processor coupled to the memory and configured to: calculate, in a case where the arithmetic operation resource is insufficient in each of the unit periods, the number of arithmetic operation resources which is the number of the arithmetic operation resources to be added in the unit period within a range not exceeding an upper limit of a total number of the arithmetic operation resources which are addable to each of the plurality of unit periods; and add the number of arithmetic operation resources calculated by the resource count calculation unit to the unit period.

### CROSS-REFERENCE TO RELATED APPLICATION

This application is based upon and claims the benefit of priority of the prior Japanese Patent Application No, 2020-99480, filed on Jun. 8, 2020, the entire contents of which are incorporated herein by reference.

### FIELD

The embodiments discussed herein are related to a resource management apparatus and a recording medium.

### BACKGROUND

A computer system such as a cloud service that increases or decreases the number of arithmetic operation resources for executing a job based on a variation in load is known. For example, the variation in load is predicted from a cycle and an execution time of the job executed in the past. In this type of computer system, a priority for executing a job is set for each user in accordance with contract contents, or an upper limit on the number of allocable arithmetic operation resources is set.

Related art is disclosed in Japanese Laid-open Patent Publication No. 2017-91330, Japanese Laid-open Patent Publication No. 2016-103113, Japanese Laid-open Patent Publication No. 2002-259144, and Japanese National Publication of International Patent Application No. 2015-511341.

### SUMMARY

According to an aspect of the embodiments, a resource management apparatus for adding an arithmetic operation resource to each of a plurality of unit periods included in an execution period for executing a job, the resource management apparatus includes: a memory; and a processor coupled to the memory and configured to: calculate, in a case where the arithmetic operation resource is insufficient in each of the unit periods, the number of arithmetic operation resources which is the number of the arithmetic operation resources to be added in the unit period within a range not exceeding an upper limit of a total number of the arithmetic operation resources which are addable to each of the plurality of unit periods; and add the number of arithmetic operation resources calculated by the resource count calculation unit to the unit period.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a system including a resource management apparatus according to an embodiment;

FIG. 2 is an explanatory diagram illustrating an example of a process of adding an arithmetic operation resource by the resource management apparatus illustrated in FIG. 1;

FIG. 3 is an explanatory diagram illustrating an example (a comparative example) of a process of adding an arithmetic operation resource by another resource management apparatus;

FIG. 4 is a block diagram illustrating an example of a system including a resource management apparatus according to another embodiment;

FIG. 5 is an explanatory diagram illustrating an example of an additional specification of a CPU core designated for each job submitted to a CPU in FIG. 4;

FIG. 6 is an explanatory diagram illustrating an example of a process of adding the CPU core by an increase and decrease control unit in FIG. 4;

FIG. 7 is an explanatory diagram illustrating another example of the process of adding the CPU core by the increase and decrease control unit;

FIG. 8 is a flowchart illustrating an example of an operation at a start of each unit period by the increase and decrease control unit in FIG. 4;

FIG. 9 is a flowchart illustrating an example of an operation of the increase and decrease control unit in FIG. 4 in a case where CPU resources are insufficient;

FIG. 10 is a flowchart illustrating a continuation of operations in FIG. 9;

FIG. 11 is a flowchart illustrating an example of a process of calculating an average number of addable resources executed by a scheduling unit in FIG. 4;

FIG. 12 is a sequence diagram illustrating an example of an operation of the CPU core which operates as the resource management apparatus in FIG. 4;

FIG. 13 is a block diagram illustrating an example of the system including the resource management apparatus according to still another embodiment;

FIG. 14 is an explanatory diagram illustrating an example of an execution prediction work table and an execution prediction table in FIG. 13;

FIG. 15 is an explanatory diagram illustrating an example of a process of adding a CPU core by an increase and decrease control unit in FIG. 13,

FIG. 16 is a flowchart illustrating an example of an operation of a period prediction control unit in FIG. 13;

FIG. 17 is a flowchart illustrating an example of a process of calculating the number of addable CPU cores, the process being executed by a scheduling unit illustrated in FIG. 13;

FIG. 18 is an explanatory diagram illustrating an example of adjusting an average number of addable resources in each unit period by the scheduling unit in FIG. 13 in a case where there is a periodic job;

FIG. 19 is a sequence diagram illustrating an example of an operation of a CPU core which operates as a resource management apparatus in FIG. 13;

FIG. 20 is a block diagram illustrating an example of the system including the resource management apparatus according to still another embodiment;

FIG. 21 is an explanatory diagram illustrating an example of an execution prediction work table and an execution prediction table in FIG. 20;

FIGS. 22A and 22B are an explanatory diagram illustrating an example of a use rate table in FIG. 20;

FIG. 23 is an explanatory diagram illustrating an example of a change in CPU use rate stored in the use rate table in FIGS. 22A and 22B;

FIG. 24 is an explanatory diagram illustrating an example of an average use rate table in FIG. 20;

FIG. 25 is an explanatory diagram illustrating an example of an operation during execution of a job of patterns 2 and 3 by a period prediction control unit in FIG. 20;

FIG. 26 is an explanatory diagram illustrating an example of an operation when the period prediction control unit in FIG. 20 ends the job of the patterns 2 and 3;

FIG. 27 is an explanatory diagram illustrating an example of a method of predicting a CPU use rate from an average CPU use rate of a plurality of periodic jobs by the scheduling unit in FIG. 20;

FIG. 28 is an explanatory diagram illustrating an example of a method of predicting a maximum CPU use rate in each unit period by the scheduling unit based on the CPU use rate predicted in FIG. 27;

FIG. 29 is a sequence diagram illustrating an example of an operation of a CPU core which operates as the resource management apparatus in FIG. 20; and

FIG. 30 is a block diagram illustrating an example of the system including the resource management apparatus according to still another embodiment.

### DESCRIPTION OF EMBODIMENTS

For example, in a case where a user has a contract for a pay-per-use charge system, an arithmetic operation resource is added in accordance with an increase in a load due to execution of the job. Since an upper limit on the number of addable arithmetic operation resources is determined by the contract contents of the pay-per-use charge, it is not possible to add arithmetic operation resources beyond the upper limit within a predetermined contract period. Therefore, in a case where the amount of load increased by the execution of the job exceeds the number of processes by the addable arithmetic operation resource, an execution time of the job becomes long.

In one aspect, the present disclosure is to reduce the number of arithmetic operation resources used to execute a job while suppressing degradation in execution efficiency of the job due to a resource shortage.

Hereinafter, embodiments will be described with reference to the drawings.

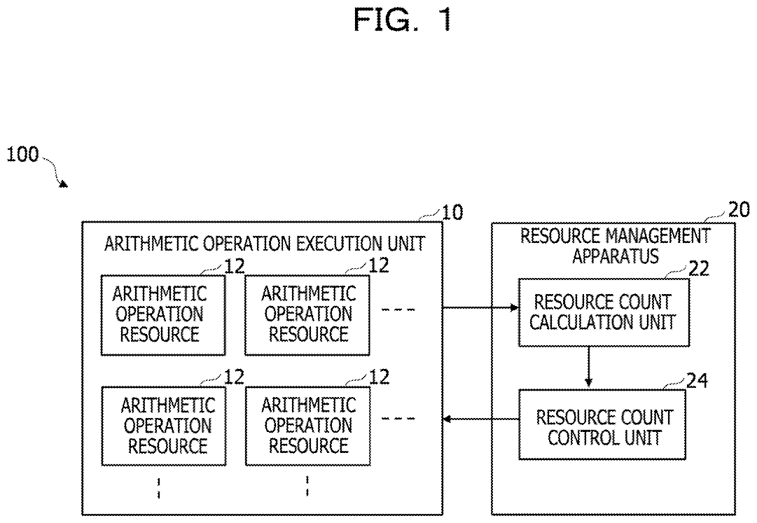

FIG. 1 illustrates an example of a system including a resource management apparatus according to an embodiment. A system 100 illustrated in FIG. 1 is, for example, an information processing apparatus such as a server or a mainframe, and includes an arithmetic operation execution unit 10 and a resource management apparatus 20. The arithmetic operation execution unit 10 includes a plurality of arithmetic operation resources 12. Each of the arithmetic operation resources 12 executes a job based on an instruction from a user who uses the system 100. Submission of the job to the arithmetic operation resource 12 may be executed by the resource management apparatus 20.

For example, the arithmetic operation execution unit 10 is a central processing unit (CPU), and the arithmetic operation resource 12 is a CPU core. Alternatively, the arithmetic operation execution unit 10 is a CPU or a CPU core, and the arithmetic operation resource 12 is a virtual machine. The arithmetic operation resource 12 may be a server, and the arithmetic operation execution unit 10 may be a cluster including a plurality of servers.

In this embodiment, a charge occurs in accordance with the number of arithmetic operation resources 12 used by the user. The charge includes a basic charge that occurs for each basic contract period (for example, monthly) and an additional charge (a pay-per-use charge) that occurs in a case where the arithmetic operation resource 12 to be used is added for each unit period obtained by dividing the basic contract period into a plurality of periods. For example, the basic charge occurs in accordance with the number of arithmetic operation resources 12 used in the basic contract period, and the amounts of maximum resources which are usable in each unit period due to the basic charge are identical with each other. For example, in the basic contract period, the number of arithmetic operation resources 12 corresponding to the basic charge may be usable in each unit period. Hereinafter, the basic contract period is also referred to as an execution period.

For example, the additional charge occurs in accordance with the total number of arithmetic operation resources 12 added to a plurality of unit periods included in the execution period. For example, in a case where the number of arithmetic operation resources 12 added to respective 3 unit periods in the execution period are 2, 3, and 2, the additional charge occurs for 7 units of the arithmetic operation resource 12. Hereinafter, the number of arithmetic operation resources 12 added to each unit period is also referred to as the number of units. For example, the number of units of the arithmetic operation resource 12 used for calculation of the additional charge is indicated by the total number of arithmetic operation resources 12 added to each unit period.

In this embodiment, an upper limit of the total number of units of the arithmetic operation resource 12 which is addable to each unit period is preset by a contract. For example, when an upper limit on the number of addable units is set to 9 and the number of units of the arithmetic operation resource 12 added to 3 unit periods is 7, the number of units of the arithmetic operation resource 12 addable to the subsequent unit period is 2.

Hereinafter, the arithmetic operation resource 12 addable to the execution period is also referred to as an extended arithmetic operation resource 12. To the arithmetic operation execution unit 10, the arithmetic operation resource 12 which is normally usable during an execution period is allocated in accordance with the basic charge, and the extended arithmetic operation resource 12 which is addable in a case where the arithmetic operation resources are insufficient in each unit period is allocated in accordance with an upper limit of the additional charge. Since the additional charge occurs in accordance with the number of units of the extended arithmetic operation resource 12 used in the execution period, the additional charge does not occur in a case where the extended arithmetic operation resource 12 is not used in the execution period.

The resource management apparatus 20 includes a resource count calculation unit 22 and a resource count control unit 24. In a case where the arithmetic operation resources 12 are insufficient fore each unit period, the resource count calculation unit 22 calculates the number of extended arithmetic operation resources 12 to be used in each unit period, within a range not exceeding the upper limit of the number of units of the extended arithmetic operation resource 12 which is usable in the execution period. The resource count control unit 24 adds the number of arithmetic operation resources 12 determined by the resource count calculation unit 22 to the unit period. For example, the resource management apparatus 20 determines whether or not to use the number of extended arithmetic operation resources 12 determined by the resource count calculation unit 22.

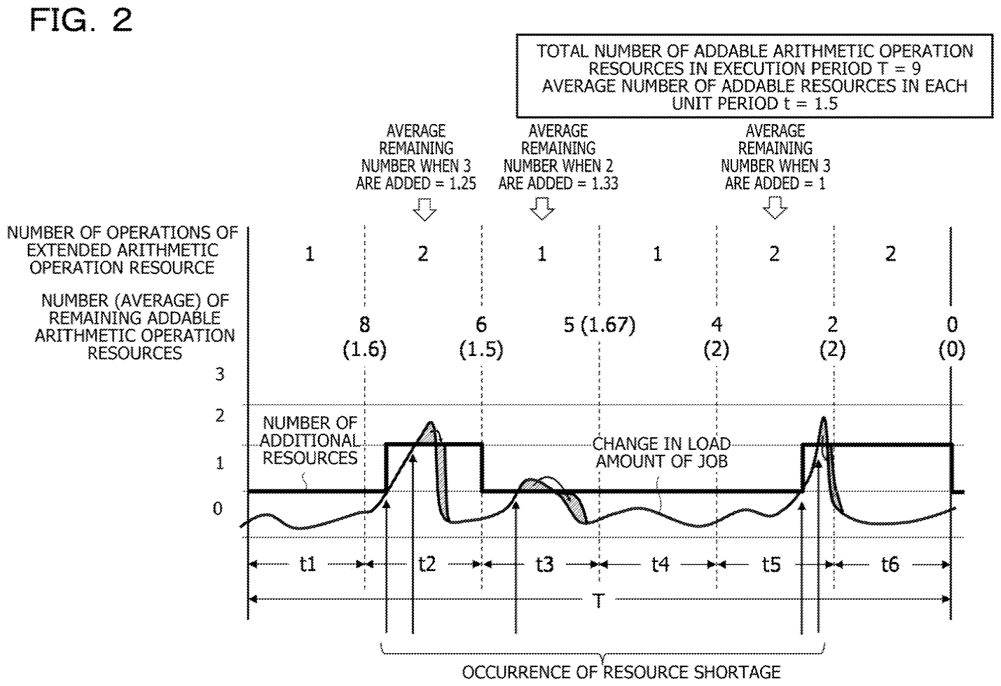

As described above, in a case where the arithmetic operation resource 12 is insufficient during the execution of the job, the extended arithmetic operation resource 12 is used, and the total number of usable units of the extended arithmetic operation resource 12 is predetermined. Thus, in a case where a large number of units are used in a unit period in a first half of an execution period, a resource shortage occurring in a second half of the execution period may not be solved, and a difference in execution efficiency of the job may occur between the first half and the second half of the execution period. The resource management apparatus 20 reduces variation in the number of extended arithmetic operation resources 12 used in each unit period for the execution period, and executes control of adding the arithmetic operation resource 12 so that the resource shortage does not occur in the second half of the execution period. The addition of the arithmetic operation resource 12 in each unit period will be described with reference to FIG. 2.

The functions of the resource management apparatus 20 may be implemented by using the arithmetic operation resources 12. In this case, the function of the resource management apparatus 20 may be executed by using the arithmetic operation resource 12 with a small load among the plurality of arithmetic operation resources 12 or may be executed by using the dedicated arithmetic operation resource 12 allocated for resource management. The arithmetic operation resources 12 that implement the functions of the resource management apparatus 20 may be sequentially switched.

FIG. 2 illustrates an example of a process of adding the arithmetic operation resource 12 by the resource management apparatus 20 illustrated in FIG. 1. For example, FIG. 2 illustrates an example of an operation executed by a control method of the resource management apparatus 20 and an operation executed by a resource management program. For clarity of a description, it is assumed that an execution period T includes 6 unit periods t (t1 to t6) in the example illustrated in FIG. 2. Although not particularly limited, in the actual system 100, the execution period T is, for example, 1 month, and the unit period t is 4 hours or the like.

In this example, an upper limit of the total number of units of the extended arithmetic operation resource 12 which is usable in the execution period T, for example, an upper limit of the total number of arithmetic operation resources 12 which are addable to each unit period t is set to 9 in advance. In this case, an average of the number of extended arithmetic operation resources 12 which are usable in each unit period t is 1.5. Hereinafter, the number of arithmetic operation resources 12 added in each unit period t is also referred to as the number of additional resources, and the average value of the number of arithmetic operation resources 12 which are addable to each unit period t is also referred to as an average number of addable resources. In FIG. 2, a thick solid line indicates a change in the number of additional resources in each unit period t, and a thick curve line indicates a change in the load amount of a job.

In the unit period t1, since an arithmetic operation resource amount corresponding to the basic charge is not sufficient for a load amount of job, the resource count calculation unit 22 determines to add one arithmetic operation resource 12 according to the load amount of job, and causes the resource count control unit 24 to add the arithmetic operation resource 12. For example, the resource count control unit 24 operates one of the predetermined number of extended arithmetic operation resources 12. The resource count calculation unit 22 calculates the remaining number (8) of units of the arithmetic operation resource 12 which is addable to the remaining unit periods t2 to t6 and an average number (1.6) of addable resources which are addable to the remaining unit periods t2 to t6.

In the middle of the unit period t2, the resource count calculation unit 22 determines that the number of additional resources is not sufficient with one due to an increase in the load amount by the execution of the job (occurrence of a resource shortage). For example, in a case where a load of the arithmetic operation resource 12 exceeds 95% of the maximum load, the resource count calculation unit 22 determines that the resource shortage occurs. In a case where the number of operations of the extended arithmetic operation resource 12 is 2, the resource count calculation unit 22 calculates the remaining number (6) of units of the arithmetic operation resource 12 which is addable to the remaining unit periods t3 to t6 and the average number (1.5) of addable resources which are addable to the remaining unit periods t3 to t6. Since the calculated average number of addable resources is equal to or larger than the preset average number (1.5) of addable resources, the resource count calculation unit 22 determines to further add one arithmetic operation resource 12 and causes the resource count control unit 24 to add the arithmetic operation resource 12.

As described above, in a case where the average number (1.5) of addable resources in the remaining unit period t is ensured to be equal to or larger than the preset average number (13) of addable resources due to the addition of the arithmetic operation resource 12, the resource management apparatus 20 adds one arithmetic operation resource 12. Thus, in a range not exceeding the upper limit of the number of units of the extended arithmetic operation resource 12 which is usable in the execution period T, efficiency of executing the job may be improved while enabling the arithmetic operation resource 12 to be added when the resource is insufficient in the subsequent unit periods t3 to t6.

After that, during the unit period t2, the resource count calculation unit 22 determines that the number of additional resources is not sufficient with two due to an increase in the load amount of job (occurrence of a resource shortage). For example, the resource shortage occurs due to execution of a process with a high load on the arithmetic operation resource 12 such as encryption. In a case where the number of operations of the extended arithmetic operation resource 12 is 3, the resource count calculation unit 22 calculates the remaining number (5) of units of the arithmetic operation resource 12 which is addable to the remaining unit periods t3 to t6 and the average number (1.25) of addable resources which are addable to the remaining unit periods t3 to t6. Since the average number of addable resources is smaller than the preset average number (1.5) of addable resources, the resource count calculation unit 22 determines not to add the arithmetic operation resource 12.

Some jobs that are not executed due to the resource shortage are executed with a delay, as indicated by a hatched frame. In a case where the average number of addable resources in the remaining unit period t is smaller than the preset average number of addable resources due to the addition of the arithmetic operation resource 12, the resource management apparatus 20 restricts the addition of the arithmetic operation resource 12. Thus, the number of additional resources which are addable to the remaining unit period t may be maintained to be equal to or larger than the preset average number of addable resources within a range not exceeding the upper limit of the number of units of the extended arithmetic operation resource 12 which is usable in the execution period T. As a result, it is possible to suppress a situation in which an extreme resource shortage occurs in the second half of the execution period T and execution efficiency of the job decreases.

Since the arithmetic operation resources 12 of 2 are added to the unit period t2, the remaining number of units of the arithmetic operation resource 12 which is addable to the remaining unit periods t3 to t6 is 6, and the average number of addable resources which are addable to the remaining unit periods t3 to t6 is 1.5. At an end of the unit period t2 or a start of the unit period t3, the resource count calculation unit 22 determines to reduce the arithmetic operation resources 12 by one since the job may be processed by adding the one arithmetic operation resource 12. The resource count calculation unit 22 issues, to the resource count control unit 24, an instruction to reduce one of the extended arithmetic operation resources 12 in operation, and the number of operating extended arithmetic operation resources 12 is reduced by one.

When the unit period t is switched, the use of the extended arithmetic operation resource 12 which is not used to execute the job is stopped and the minimum number of extended arithmetic operation resources 12 are operated, so that the number of units of the arithmetic operation resource 12 which is addable to the subsequent unit period t may be increased. Therefore, it is possible to reduce a probability that a resource shortage occurs in the second half of the execution period T, and to suppress a reduction in efficiency of executing the job during the entire execution period T.

In the middle of the unit period t3, the resource count calculation unit 22 determines that the number of additional resources is not sufficient with one due to an increase in the load amount of job (occurrence of a resource shortage). In a case where the number of operations of the extended arithmetic operation resource 12 is 2, the resource count calculation unit 22 calculates the remaining number (4) of units of the arithmetic operation resource 12 which is addable to the remaining unit periods t4 to t6 and the average number (1.33) of addable resources which are addable to the remaining unit periods t4 to t6.

Since the average number of addable resources is smaller than the preset average number (1.5) of addable resources, the resource count calculation unit 22 determines not to add the arithmetic operation resource 12. Some jobs that are not executed due to the resource shortage are executed with a delay, as indicated by a hatched frame. Since the one arithmetic operation resource 12 is added to the unit period t3, the remaining number of units of the arithmetic operation resource 12 which is addable to the remaining unit periods t4 to t6 is 5, and the average number of addable resources which are addable to the remaining unit periods t4 to t6 is 1.67.

At a start of the unit period t4, the resource count calculation unit 22 determines that the job may be processed in a state in which the addition of one arithmetic operation resource 12 is maintained, and does not change the number of extended arithmetic operation resources 12 to be operated. Since the one arithmetic operation resource 12 is added to the unit period t4, the remaining number of units of the arithmetic operation resource 12 which is addable to the remaining unit periods t5 to t6 is 4, and the average number of addable resources which are addable to the remaining unit periods t5 to t6 is 2.

At a start of the unit period t5, the resource count calculation unit 22 determines that the job may be processed in a state in which the addition of one arithmetic operation resource 12 is maintained, and does not change the number of extended arithmetic operation resources 12 to be operated. In the middle of the unit period t5, the resource count calculation unit 22 determines that the number of additional resources is not sufficient with one due to an increase in the load amount of job (occurrence of a resource shortage).

In a case where the number of operations of the extended arithmetic operation resource 12 is 2, the resource count calculation unit 22 calculates the remaining number (2) of units of the arithmetic operation resource 12 which is addable to the remaining unit period t6 and the average number (2) of addable resources which are addable to the remaining unit period t6. Since the average number of addable resources is equal to or larger than the preset average number (1.5) of addable resources, the resource count calculation unit 22 determines that the number of additional arithmetic operation resources 12 is set to 2, and causes the resource count control unit 24 to add one arithmetic operation resource 12.

After that, during the unit period t5, the resource count calculation unit 22 determines that the number of additional resources is not sufficient with two due to an increase in the load amount of job (occurrence of a resource shortage). In a case where the number of operations of the extended arithmetic operation resource 12 is 3, the resource count calculation unit 22 calculates the remaining number (1) of units of the arithmetic operation resource 12 which is addable to the remaining unit period t6 and the average number (1) of addable resources which are addable to the remaining unit period t6. Since the average number of addable resources is smaller than the preset average number (1.5) of addable resources, the resource count calculation unit 22 determines not to add the arithmetic operation resource 12.

At a start of the unit period t6, the resource count calculation unit 22 may add the arithmetic operation resources 12 of 2 to the unit period t5, and the number of additional resources which are executable without delaying the job is 2, so that the resource count calculation unit 22 does not reduce the extended arithmetic operation resources 12 in operation. In the last unit period t6, there is no subsequent unit period t, so that the resource count calculation unit 22 does not calculate the remaining number of units of the addable arithmetic operation resource 12. In a case where the load amount of job increases, the resource count calculation unit 22 adds the arithmetic operation resource 12 until the remaining arithmetic operation resources 12 are used up. As described above, in the last unit period t6, the number of arithmetic operation resources to be added is determined within the range of the upper limit of the total number of units of the usable extended arithmetic operation resources regardless of the average number of addable resources, so that execution efficiency of the job may be improved without exceeding the upper limit of an additional charge.

As illustrated in FIG. 2, in this embodiment, the arithmetic operation resource 12 is addable for each unit period t into which the execution period T is subdivided, so that an increase in cost due to the addition of the arithmetic operation resource 12 may be made to be a cost corresponding to a load amount generated due to the execution of the job. A specific job (such as an encryption process) with a large load amount may be executed at a low cost without affecting execution performance of the existing job for business.

The cost incurred due to the addition of the arithmetic operation resource 12 includes, for example, an additional cost of the arithmetic operation resource 12 and a license fee (a processor license depending on the number of arithmetic operation resources 12 to be added) of software associated with the additional cost.

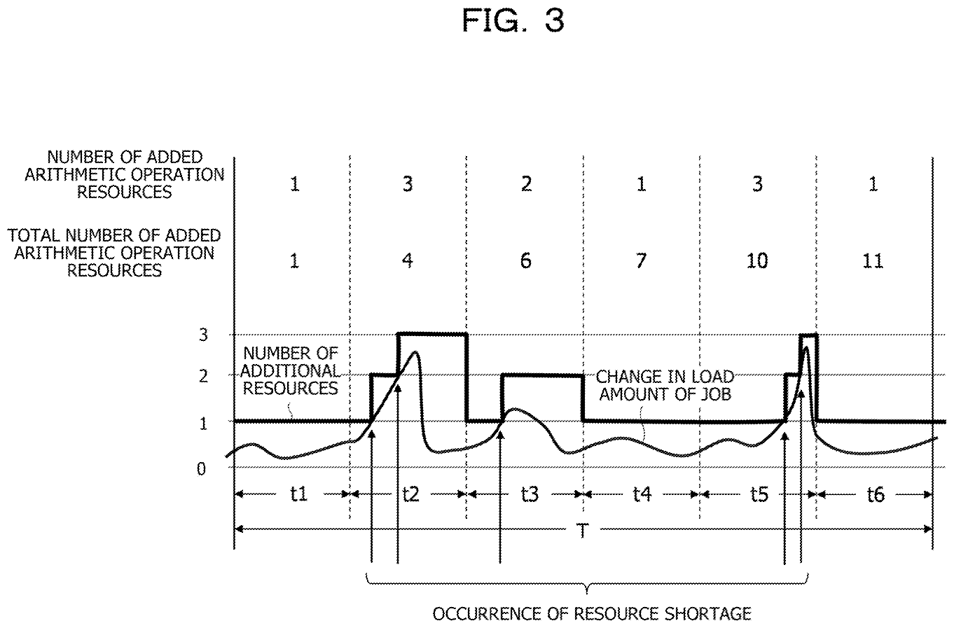

FIG. 3 illustrates an example (a comparative example) of a process of adding an arithmetic operation resource by another resource management apparatus. A detailed description of a process having the same manner as illustrated in FIG. 2 will be omitted herein. A change in the load amount of job has the same manner as that in FIG. 2. In FIG. 3, the number of additional arithmetic operation resources 12 is not limited.

In this case, in the unit periods t2, t3, and t5, every time the arithmetic operation resource 12 becomes insufficient due to an increase in the load amount of job, the arithmetic operation resource 12 is added. For example, in the unit periods t2, t3, and t5, in a case where the arithmetic operation resource 12 is slightly insufficient due to the increase in the load amount of job, the arithmetic operation resource 12 is added.

Thus, the total number of units of the arithmetic operation resource 12 added to the execution period T is 11, which is larger than that in FIG. 2 by 2. Meanwhile, in the example illustrated in FIG. 3, although the total number of units of the arithmetic operation resource 12 is increased, execution efficiency of the job is approximately the same as that in FIG. 2.

As described above, in the embodiment illustrated in FIGS. 1 and 2, the resource management apparatus 20 adds one arithmetic operation resource 12 in a case where the average number of addable resources in the remaining unit period t may be ensured to be equal to or larger than the preset average number of addable resources by adding the arithmetic operation resource 12. Thus, in a range not exceeding the upper limit of the total number of units of the extended arithmetic operation resource 12 which is usable in the execution period T, efficiency of executing the job may be improved while enabling the arithmetic operation resource 12 to be added when the resource is insufficient in the subsequent unit period t.

In a case where the average number of addable resources in the remaining unit period t is smaller than the preset average number of addable resources due to the addition of the arithmetic operation resource 12, the resource management apparatus 20 restricts the addition of the arithmetic operation resource 12. Thus, the number of additional resources which are addable to the remaining unit period t may be maintained to be equal to or larger than the preset average number of addable resources within a range not exceeding the upper limit of the number of units of the extended arithmetic operation resource 12 which is usable in the execution period T. As a result, it is possible to suppress a situation in which an extreme resource shortage occurs in the second half of the execution period T and execution efficiency of the job decreases.

As described above, it is possible to reduce the number of arithmetic operation resources 12 used to execute the job while suppressing a decrease in efficiency of executing the job due to a resource shortage, and it is possible to suppress an additional charge from exceeding the upper limit.

When the unit period t is switched, the use of the extended arithmetic operation resource 12 which is not used to execute the job is stopped and the minimum number of extended arithmetic operation resources 12 are operated, so that the number of units of the arithmetic operation resource 12 which is addable to the subsequent unit period t may be increased. Therefore, it is possible to reduce a probability that a resource shortage occurs in the second half of the execution period T, and to suppress a reduction in efficiency of executing the job during the entire execution period T.

In the last unit period t6, the number of arithmetic operation resources to be added is determined within the range of the upper limit of the total number of units of the usable extended arithmetic operation resources regardless of the average number of addable resources, so that execution efficiency of the job may be improved without exceeding the upper limit of an additional charge.

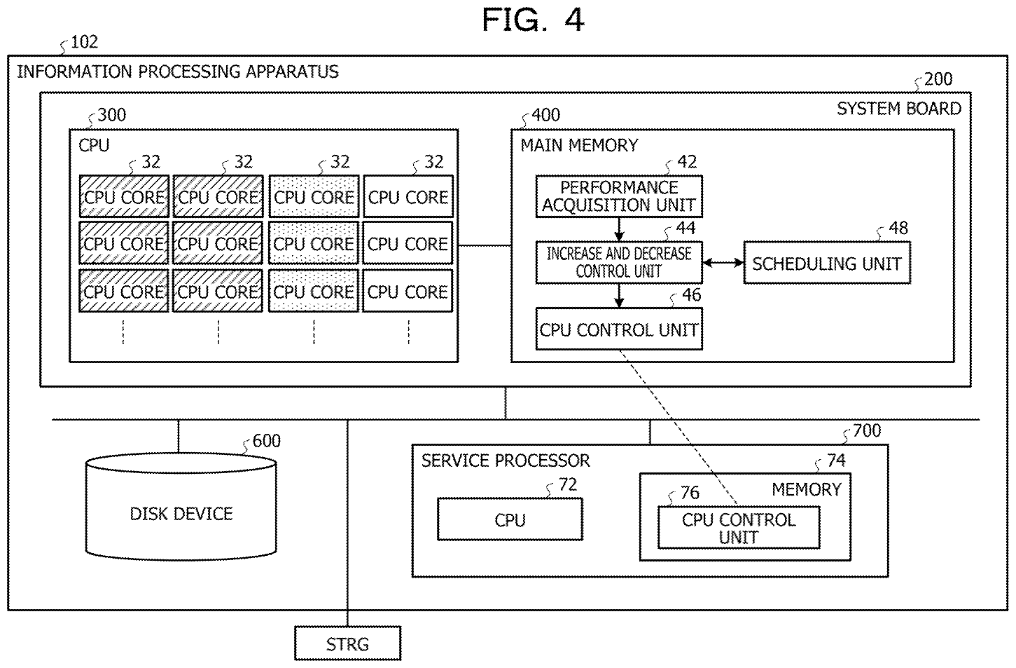

FIG. 4 illustrates an example of a system including a resource management apparatus according to another embodiment. A detailed description of a component similar to or the same as illustrated in FIG. 1 will be omitted herein. An information processing apparatus 102 illustrated in FIG. 3 is, for example, a system such as a server or a mainframe. The information processing apparatus 102 includes a system board 200, and a disk device 600 and a service processor 700 that are coupled to the system board 200 via a bus.

The system board 200 includes a CPU 300 including a plurality of CPU cores 32 and a main memory 400 coupled to the CPU 300. Each of the CPU cores 32 executes an information processing program stored in the main memory 400 based on an instruction from a user of the information processing apparatus 102 to execute a job. The CPU core 32 is an example of an arithmetic operation resource for executing the job.

At least one of the CPU cores 32 executes the resource management program stored in the main memory 400 to implement functions of a performance acquisition unit 42, an increase and decrease control unit 44, a CPU control unit 46, and a scheduling unit 48. The CPU core 32 that implements the functions of the performance acquisition unit 42, the increase and decrease control unit 44, the CPU control unit 46, and the scheduling unit 48 by executing the resource management program is an example of a resource management apparatus. The increase and decrease control unit 44 and the scheduling unit 48 are an example of a resource count calculation unit, and the CPU control unit 46 is an example of a resource count control unit.

The service processor 700 includes a CPU 72, and a memory 74 coupled to the CPU 72 and accessed by the CPU 72. The CPU 72 implements a function of the CPU control unit 76 by executing a management program stored in the memory 74. Based on an instruction from the CPU 300, the CPU control unit 76 performs control to increase or decrease the number of CPU cores 32 used for executing a job of the user.

The disk device 600 is a hard disk drive (HDD), a solid-state drive (SSD), or the like, and stores, for example, a resource management program to be loaded to the main memory 400. The resource management program may be stored in a recording medium STRG such as a Universal Serial Bus (USB) memory coupled to the information processing apparatus 102 and transferred from the recording medium STRG to the main memory 400. The recording medium STRG may be a compact disc read-only memory (CD-ROM), Digital Versatile Disc (DVD) (registered trademark), or the like.

Based on information from the CPU 300 or the service processor 700, the performance acquisition unit 42 acquires a CPU use rate of the CPU core 32 allocated to the user in accordance with a basic charge and an additional charge, and notifies the increase and decrease control unit 44 of the acquired CPU use rate. For example, the CPU use rate is a ratio of a load amount during execution of the job to maximum performance (100%) at which the user job is executable by a predetermined number of CPU cores 32 allocated to the user. In a case where a plurality of jobs are executed in parallel, the performance acquisition unit 42 may acquire the CPU use rate of each job.

Based on the CPU use rate acquired by the performance acquisition unit 42, the increase and decrease control unit 44 determines whether or not to increase the number of CPU cores 32 to be used and determines whether or not to decrease the increased number of CPU cores 32. The increase and decrease control unit 44 issues an instruction to cause the scheduling unit 48 to calculate an average number of addable resources, which is an average of the number of CPU cores 32 which are addable to each unit period t.

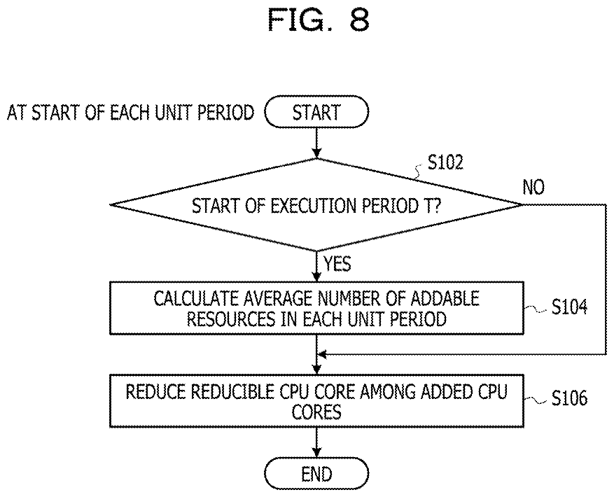

Determination for increasing the number of CPU cores 32 by the increase and decrease control unit 44 is executed in a case where the CPU resource is insufficient. The increase and decrease control unit 44 determines to decrease the CPU core 32 at a time of switching the unit period t such as at a start or an end of the unit period t. The increase and decrease control unit 44 notifies the CPU control unit 46 of the determination result of increase or decrease of the CPU core 32. An example of the operation of the increase and decrease control unit 44 is illustrated in FIGS. 8 to 10.

Based on the notification of the CPU use rate from the increase and decrease control unit 44, the CPU control unit 46 outputs the instruction to increase or decrease the number of CPU cores 32 to be used for executing the job, to the CPU control unit 76 of the service processor 700. The CPU control unit 46 increases or decreases the number of CPU cores 32 to be used in each unit period t.

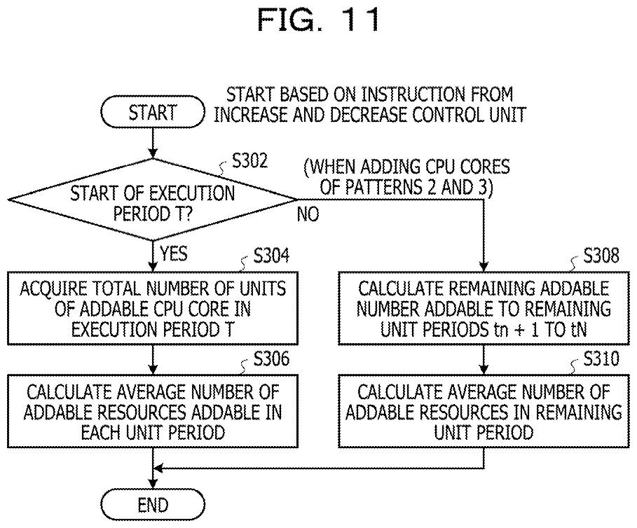

At a start of the execution period T (a basic contract period), the scheduling unit 48 calculates the average number of addable resources, which is an average of the number of CPU cores 32 addable to each unit period t. In a case where the CPU core 32 is added by the increase and decrease control unit 44, the scheduling unit 48 recalculates the average number of addable resources, which is an average of the number of CPU cores 32, which are addable to the remaining unit period t. An example of the operation of the scheduling unit 48 is illustrated in FIG. 11.

In FIG. 4, the CPU cores 32 indicated by hatched lines indicate the CPU cores 32 usable for a basic charge, and the number of used CPU cores 32 does not increase or decrease in the execution period T. The shaded CPU cores 32 indicate the extension CPU cores 32 usable for an additional charge. The number of used extension CPU cores 32 to be used for executing the job is increased due to occurrence of a resource shortage, and is decreased in a case where it is possible to reduce the number of extension CPU cores 32 when the unit period t is switched.

As described above, the CPU 300 includes the extension CPU core 32 usable for an additional charge, in addition to the CPU core 32 to be used in a range of a basic charge. Thus, it is not desirable to add a new CPU 300 to the system board 200 for the extension CPU core 32, and a cost for designing, manufacturing, and introducing the dedicated hardware does not occur. Since the job is executed by using the common CPU core 32 in the CPU 300 including the extension CPU core 32, a general-purpose process may be executed. Since the extension CPU core 32 is used in a case where the number of resources is insufficient due to an increase in the load amount, the additional amount of software license amount may be calculated in accordance with the number of used extension CPU cores 32.

Positions at which the CPU core 32 to be used for the basic charge and the extension CPU core 32 to be used for the additional charge are allocated in the CPU 300 may be changed at any timing. The system board 200 may include the two CPUs 300 or more. In this case, the CPU core 32 mounted on at least one of a plurality of CPUs 300 is used to execute the job of the user.

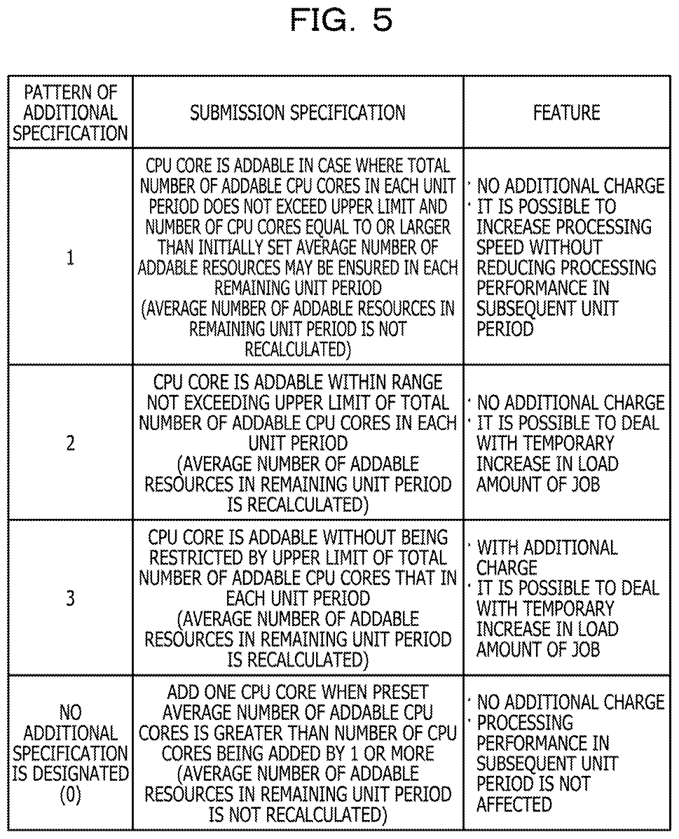

FIG. 5 illustrates an example of an additional specification of the CPU core 32 designated for each job submitted to the CPU 300 in FIG. 4. For example, as the additional specifications, there are a pattern 1, a pattern 2, a pattern 3, and no designation. Hereinafter, a specification when the additional specification is not designated is also referred to as a pattern 0.

In the pattern 1, the CPU core 32 may be added in a case where a total number (a total number of units) of the CPU cores 32 which are addable to each unit period t is not exceeded the upper limit, and the CPU cores 32 may be ensured to be equal to or more than an average number of addable resources which are initially set and newly set after the CPU core 32 is added to the patterns 2 and 3 to be described below, in each remaining unit period t. The operation illustrated in FIG. 2 corresponds to an operation of the pattern 1.

Thus, in the pattern 1, even in a case where the CPU core 32 is added, the average number of addable resources which are initially set and reset is maintained. Thus, since the total number of units of the CPU core 32 added for each unit period t is suppressed to be equal to or smaller than a preset upper limit, a new additional charge does not occur. In the pattern 1, since the initially set and reset average number of addable resources are not changed, processing performance in the subsequent unit period t does not decrease, and in a case where the load amount of job increases, it is possible to improve a processing speed of the job by adding the CPU core 32.

In the pattern 2, the CPU core 32 may be added within a range not exceeding the upper limit of the total number (the total number of units) of CPU cores 32 which are addable to each unit period t, and a new additional charge does not occur. In a case where the CPU core 32 is added in each unit period t, the average number of addable resources in the remaining unit period t is recalculated. In the pattern 2, since an additional condition of the CPU core 32 is relieved as compared with the pattern 1, even in a case where the load amount of job temporarily increases, it is possible to process the job without decreasing the processing speed. On the other hand, as the CPU core 32 is added, the average number of addable resources in the remaining unit period t decreases, and processing performance in the subsequent unit period t may deteriorate.

In the pattern 3, the CPU core 32 may be added in each unit period t without being restricted by the upper limit of the total number (the total number of units) of the CPU cores 32 which are addable to each unit period t. Meanwhile, in a case where the charge amount exceeds the upper limit, a new additional charge occurs. In a case where the CPU core 32 is added in each unit period t, the average number of addable resources in the remaining unit period t is recalculated. In the pattern 3, even when the total number of CPU cores which are addable to the period T exceeds the upper limit, it is possible to add the CPU core 32, so that as compared with the pattern 2, even in a case where the load amount of job temporarily increases, it is possible to process the job without decreasing the processing speed. On the other hand, in the same manner as the pattern 2, as the CPU core 32 is added, the average number of addable resources in the remaining unit period t decreases, and processing performance in the subsequent unit period t may deteriorate.

In the pattern 0, at a start of each unit period t, when the average number of addable resources, which is an average number of addable CPU cores 32 in the unit period t set in advance, is larger than the number of CPU cores 32 being added in the unit period t by 1 or more, one CPU core 32 is added. In the pattern 0, even in a case where the CPU core 32 is added, the average number of addable resources in the remaining unit period t is not recalculated, and the average number of addable resources initially set and reset is maintained. In the pattern 0, in a case where the additional charge does not occur and the amount of addable CPU core 32 is sufficient, an increase in the amount of job load may be handled without a reduction in the processing performance in the subsequent unit period t.

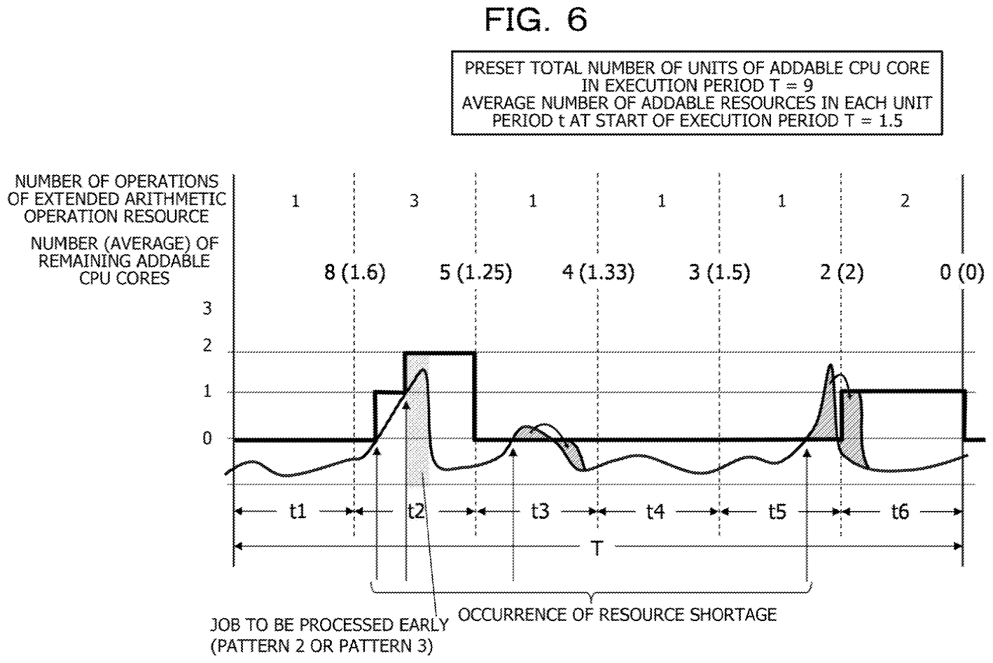

FIG. 6 illustrates an example of a process of adding the CPU core 32 by the increase and decrease control unit 44 in FIG. 4. A detailed description of an operation having the same manner as illustrated in FIG. 2 will be omitted herein. For example, FIG. 6 illustrates an example of an operation executed by a control method for a resource management apparatus and an operation performed by a resource management program.

The number of unit periods t (t1 to t6) included in the execution period T and an upper limit (9) of the total number of units of the CPU core 32 (the arithmetic operation resource) which are addable to each unit period t set in advance are the same as those in FIG. 2. Thus, the average number of addable resources, which is an average number of CPU cores 32 which are addable to each unit period t, is 1.5 at a start of the execution period T, Hereinafter, the number of CPU cores 32 added to each unit period t is also referred to as the number of additional resources.

A change in the load amount of job indicated by a thick curve line (a curve line before the process is delayed as indicated by a hatched frame) is the same as that in FIG. 2. In FIG. 6, during execution of at least one job for which the pattern 1 is designated, a job for which the pattern 2 or the pattern 3 is designated and which is to be processed early is submitted in the middle of the unit period t2. The process in the unit period t1, the remaining number (8) of units of the CPU core 32 that is addable after the unit period t1, and the average number (1.6) of addable resources are the same as those in FIG. 2.

In the middle of the unit period t2, the performance acquisition unit 42 notifies the increase and decrease control unit 44 of a CPU use rate being increased due to an increase in the load amount of job. The increase and decrease control unit 44 determines that the number of additional resources is not sufficient with one (occurrence of a resource shortage), In the same manner as FIG. 2, for example, in a case where a load of the CPU core 32 exceeds 95% of the maximum load, the increase and decrease control unit 44 determines the occurrence of the resource shortage. As a determination reference of the occurrence of the resource shortage, the same applies to the following embodiment. In a case where the number of added CPU cores 32 is set to 2, the increase and decrease control unit 44 causes the scheduling unit 48 to calculate the remaining number (6) of units of addable CPU core 32 and the average number (1.5) of addable resources in the remaining unit periods t3 to t6.

Since the average number of addable resources calculated by the scheduling unit 48 is equal to or larger than the preset average number (1.5) of addable resources, the increase and decrease control unit 44 determines to further add one CPU core 32 and instructs the CPU control unit 46 to add the CPU core 32.

After that, during the unit period t2, the job for which the process in the pattern 2 or the pattern 3 is designated is submitted. Based on the notification of the CPU use rate from the performance acquisition unit 42, the increase and decrease control unit 44 determines that the number of additional CPU cores 32 is not sufficient with two due to submission of the job of the pattern 2 or the pattern 3 (occurrence of a resource shortage). Thus, the increase and decrease control unit 44 determines to further add one CPU core 32 and instructs the CPU control unit 46 to add the CPU core 32, In a case where the number of added CPU cores 32 is set to 3, the increase and decrease control unit 44 causes the scheduling unit 48 to calculate the remaining number (5) of units of addable CPU core 32 and the average number (1.25) of addable resources in the remaining unit periods t3 to t6.

By setting the number of added CPU cores 32 to 3, processing efficiency of the job may be improved, as compared with the case where the number of added CPU cores 32 is 2. As described above, in a case where the CPU resource for executing the job for which the pattern 2 or the pattern 3 is designated is insufficient, the process may be completed quickly by adding the CPU core 32, regardless of the decrease in the average number of addable resources in the subsequent unit period t. For example, in the unit period t2 in FIG. 6, it is possible to suppress the delay of the job as indicated by the hatched frame in the unit period t2 in FIG. 2. At this time, since the process of adding the CPU core 32 may be executed without exceeding the upper limit of the total number of units of the CPU core 32 which is addable to each unit period t, it is possible to suppress the additional charge from exceeding an upper limit while improving execution efficiency of the job.

Based on the notification of the CPU use rate from the performance acquisition unit 42, the increase and decrease control unit 44 determines that the job may be processed by using one extension CPU core 32 at the start of the unit period t3, and issues an instruction to reduce the number of CPU cores 32 to be used by 2 to the CPU control unit 46. A process in the unit periods t3 and t4 has the same manner as that in FIG. 2 except that the remaining number (4 and 3) of CPU cores 32 which are addable to the remaining unit period t is different from the average number (1.33 and 1.5) of addable resources which are addable to the remaining unit period t.

In the middle of the unit period t5, based on the notification of the CPU use rate from the performance acquisition unit 42, the increase and decrease control unit 44 determines that the number of additional resources is not sufficient with one due to the increase in the load amount of job (occurrence of a resource shortage). The pattern 1 is designated for the job with the increased load amount. In a case where the number of added CPU cores 32 is set to 2, the increase and decrease control unit 44 causes the scheduling unit 48 to calculate the remaining number (1) of units of addable CPU core 32 and the average number (1) of addable resources in the remaining unit period t6.

Since the average number of addable resources is smaller than the average number (1.25) of addable resources recalculated in the unit period t2, the increase and decrease control unit 44 determines not to add the CPU core 32. In the unit period t5, since the number of additional CPU cores 32 is maintained at one, the number of CPU cores 32 which are addable to the remaining unit period t6 is 2, and the average number of addable resources which are addable to the remaining unit period t6 is 2.

After that, in the unit period t6, a job indicated by a hatched frame and not executed in the unit period t5 is submitted with a delay. Based on the notification of the CPU use rate from the performance acquisition unit 42, the increase and decrease control unit 44 determines that the number of additional resources is not sufficient with one due to the increase in the load amount of job (occurrence of a resource shortage). Since the unit period t6 is the last unit period of the execution period T, the increase and decrease control unit 44 determines to add all the remaining CPU cores 32 (2) and instructs the CPU control unit 46 to add the remaining CPU cores 32. Thus, the job which is not executed in the unit period t5 due to the resource shortage is executed with the delay in the unit period t6 as indicated by the hatched frame in the same manner as in FIG. 2.

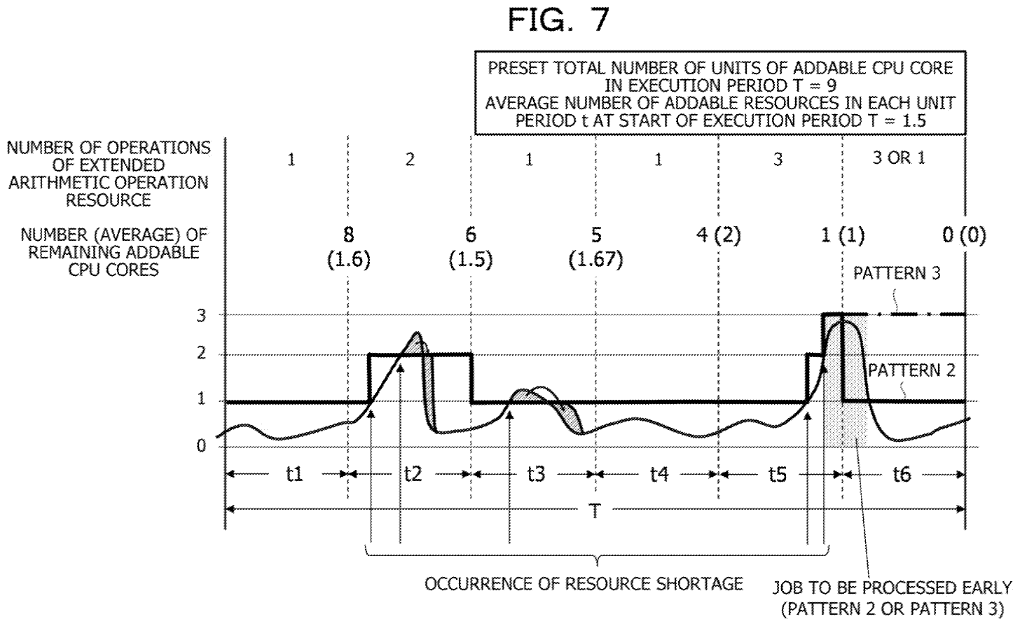

FIG. 7 illustrates another example of the process of adding the CPU core 32 by the increase and decrease control unit 44 in FIG. 4. A detailed description of an operation having the same manner as illustrated in FIGS. 2 and 6 will be omitted herein. For example, FIG. 7 illustrates an example of an operation executed by a control method for a resource management apparatus and an operation performed by a resource management program.

In FIG. 7, a job for which the pattern 1 is designated is submitted during the unit periods t1 to t6, and a job for which the pattern 2 or the pattern 3 is designated is submitted across the unit periods t5 and t6. Thus, in the same manner as in FIG. 2, the two CPU cores 32 are added in the unit period t2, and one CPU core 32 is added in the unit periods t1, t3, and t4.

In a case where the job for which the pattern 2 or the pattern 3 is designated is submitted in the second half of the unit period t5, the increase and decrease control unit 44 sequentially adds the CPU cores 32 one by one in accordance with an increase in the load amount of job, and the number of CPU cores 32 added in the unit period t5 becomes 3. Therefore, at a start of the unit period t6, the number of remaining addable CPU cores 32 is 1, and the average number of addable resources which are addable in the unit period t6 is 1.

In a case where the pattern 3 is designated for the job, the increase and decrease control unit 44 adds three CPU cores 32 in accordance with the increase in the load amount of job as indicated by a thick dashed line. As a result, the total number of units of the CPU core 32 added to the execution period T is 12. Thus, although an additional charge newly occurs, the execution period of the job for which the pattern 3 is designated may be minimized.

On the other hand, when the pattern 2 is designated for the job, as indicated by the thick solid line, the increase and decrease control unit 44 adds one CPU core 32 so as not to exceed the upper limit (9) of the total number of units of the CPU core 32 which is addable to the execution period T. In this case, although not illustrated in a hatched frame, the process for the two CPU cores 32, which is not executable at the beginning of the unit period t6, is executed with a delay in the unit period t6.

As illustrated in FIG. 7, when the job for which the pattern 2 or the pattern 3 is designated is submitted, it is possible to selectively execute a job for suppressing an additional charge and a job for prioritizing a processing speed. For example, it is possible to selectively use, for each job, whether priority is given to a processing cost of the job or processing performance of the job.

FIG. 8 illustrates an example of an operation at a start of each unit period t by the increase and decrease control unit 44 in FIG. 4. For example, FIG. 8 illustrates an example of a resource management apparatus control method and a resource management program.

First, in step S102, the increase and decrease control unit 44 determines whether or not the execution period T starts (for example, whether or not it is a start of the unit period t1). In a case where the execution period T starts, the increase and decrease control unit 44 executes step S104, and in a case where the execution period T does not start, the increase and decrease control unit 44 executes step S106.

In step S104, the increase and decrease control unit 44 calculates an average number of addable resources, which is an average of the number of CPU cores 32 which are addable to each unit period t. After the calculation, the increase and decrease control unit 44 executes step S106. For example, the calculation of the average number of addable resources is executed by the scheduling unit 48 that receives an instruction from the increase and decrease control unit 44. An example of the calculation of the average number of addable resources by the scheduling unit 48 is illustrated in FIG. 11.

In step S106, in a case where it is possible to reduce the number of CPU cores 32 to be added in the immediately preceding unit period t, the increase and decrease control unit 44 instructs the CPU control unit 46 to reduce the number of CPU cores 32, and ends the process illustrated in FIG. 8. At the start of the execution period T, the immediately preceding unit period t is the last unit period t included in the immediately preceding execution period T.

The increase and decrease control unit 44 calculates the desirable number of extension CPU cores based on a CPU use rate of the extension CPU core 32 used in the job currently being executed. For example, the increase and decrease control unit 44 rounds up a value obtained by dividing the CPU use rate (%) of the extension CPU core 32 used in the job currently being executed by 100 to the nearest whole number so as to obtain the desirable number of extension CPU cores 32. In a case where the CPU use rate of the extension CPU core 32 is 120%, the desirable number of extension CPU cores 32 is 2, and in a case where the CPU use rate of the extension CPU core 32 is 0%, the desirable number of extension CPU cores 32 is 0.

The increase and decrease control unit 44 selects a smaller value between the obtained desirable number of the extension CPU cores 32 and the average number of addable resources calculated in step S104. The increase and decrease control unit 44 continues to use the selected number of extension CPU cores 32 and instructs the CPU control unit 46 to stop the use of more than the selected number of extension CPU cores 32.

For example, it is assumed that the desirable number of extension CPU cores 32 is 1, the average number of addable resources is 2, and the number of extension CPU cores 32 in use is 3. In this case, the increase and decrease control unit 44 determines to continue to use one extension CPU core 32 which is equal to the desirable number and stop the use of the two extension CPU cores 32 (to reduce the two added CPU cores 32). For example, it is assumed that the desirable number of extension CPU cores 32 is 2, the average number of addable resources is one, and the number of extension CPU cores 32 in use is 2. In this case, the increase and decrease control unit 44 determines to continue to use one extension CPU core 32 which is equal to the average number of addable resources and stop the use of one extension CPU core 32 (to reduce the one added CPU core 32).

The increase and decrease control unit 44 instructs the CPU control unit 46 to reduce the determined number of CPU cores 32. Based on the instruction from the increase and decrease control unit 44, the CPU control unit 46 reduces the added CPU core 32, via the CPU control unit 76 of the service processor 700. The process of step S106 is, for example, a process of stopping the use of two among the three extension CPU cores 32 in use at the start of the unit period t3 in FIG. 6.

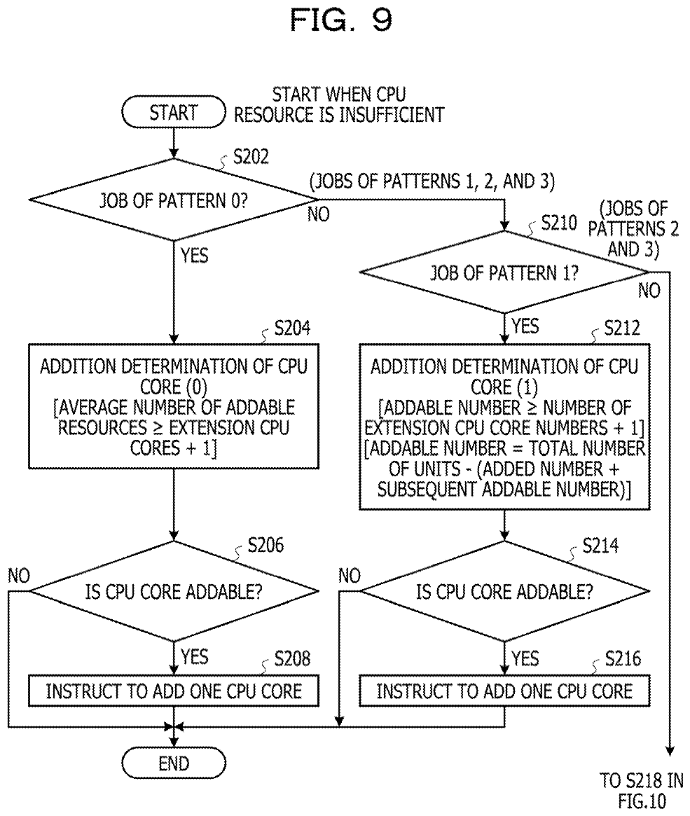

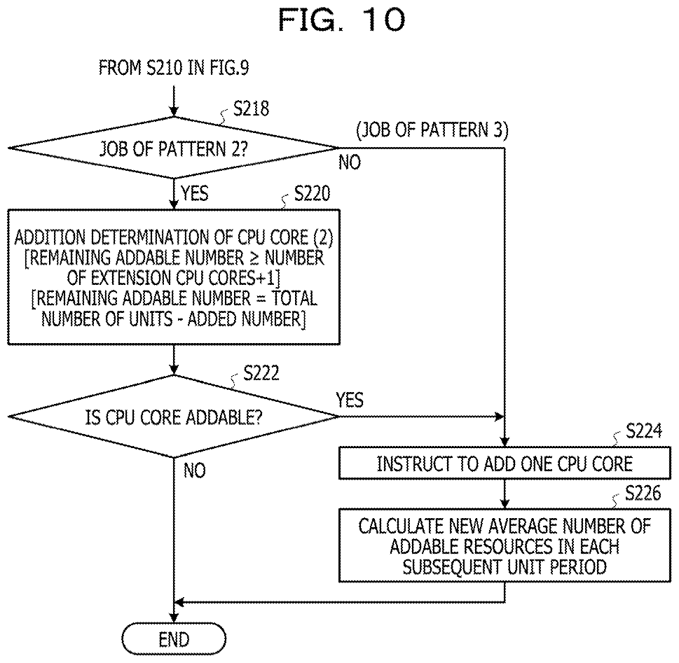

FIGS. 9 and 10 illustrate an example of an operation of the increase and decrease control unit 44 in a case where a CPU resource is insufficient. For example, FIGS. 9 and 10 illustrate an example of a resource management apparatus control method and a resource management program. FIG. 9 is started in a case where the increase and decrease control unit 44 determines a shortage of the CPU resource based on a CPU use rate acquired by the performance acquisition unit 42. The performance acquisition unit 42 may determine the insufficiency of the CPU resource and notify the insufficiency to the increase and decrease control unit 44.

First, in step S202, in a case where only a job having the pattern 0 illustrated in FIG. 5 is executed in the unit period t, the increase and decrease control unit 44 executes step S204. In a case where at least one of jobs of pattern 1 to pattern 3 in FIG. 5 is executed in the unit period t, the increase and decrease control unit 44 executes step S210.

In step S204, the increase and decrease control unit 44 executes addition determination (0) of the CPU core 32. For example, in a case where an average number of addable resources is equal to or more than the number of currently added CPU cores+1, the increase and decrease control unit 44 determines that the CPU core 32 is addable. Next, in step S206, in a case where the addition determination (0) in step S204 is true, the increase and decrease control unit 44 determines that the CPU core 32 is addable, and executes step S208. In a case where the addition determination (0) in step S204 is false, the increase and decrease control unit 44 ends the process illustrated in FIGS. 9 and 10.

In step S208, the increase and decrease control unit 44 issues, to the CPU control unit 46, an instruction to add one CPU core 32, and ends the process illustrated in FIGS. 9 and 10. For example, in a case where only the job of the pattern 0 is executed and the average number of addable resources is equal to or more than the number of currently used extension CPU cores+1, one CPU core 32 is added.

In step S210, the increase and decrease control unit 44 executes step S212 in a case where the job of the pattern 1 is executed and the jobs of the pattern 2 and the pattern 3 are not executed in FIG. 5, in the unit period t. In a case where the job having at least one of the patterns 2 and 3 in FIG. 5 is executed in the unit period t, the increase and decrease control unit 44 executes step S218 in FIG. 10.

In step S212, the increase and decrease control unit 44 executes the addition determination (1) of the CPU core 32. For example, the increase and decrease control unit 44 determines that the CPU core 32 is addable in a case where the number of addable CPU cores 32, which is the number of CPU cores 32 addable to the unit period tn, is equal to or larger than the number of currently added extension CPU cores+1.

In order to calculate the addable number, the increase and decrease control unit 44 first calculates a total number (an added number) of units of the CPU core 32 added so far including the unit period tn, in the execution period T. The increase and decrease control unit 44 calculates a total number of addable units of the CPU core 32 (the number of subsequently addable units) in the unit period tn+1 to tN (N is a total number of the unit periods t within the execution period T) after the unit period tn. For example, the number of subsequently addable units is obtained by multiplying the number of subsequent unit periods tn+1 to tN by the average number of addable resources.

The increase and decrease control unit 44 sets a value obtained by subtracting a sum of the added number and the subsequently addable number from the total number (the upper limit value) of units of the CPU core 32 which is addable to each unit period t, to the addable number, which is the number of CPU cores 32 which are addable to the unit period tn.

Next, in step S214, in a case where the addition determination (1) in step S212 is true, the increase and decrease control unit 44 determines that the CPU core 32 is addable, and executes step S216. In a case where the addition determination (1) in step S212 is false, the increase and decrease control unit 44 ends the process illustrated in FIGS. 9 and 10.

In step S216, the increase and decrease control unit 44 issues, to the CPU control unit 46, an instruction to add one CPU core 32, and ends the process illustrated in FIGS. 9 and 10. For example, in the case where the job having the pattern 1 is executed and the jobs having the patterns 2 and 3 are not executed, and in a case where the number of CPU cores 32 which are addable in the unit period tn is equal to or more than the number of currently added extension CPU cores+1, one CPU core 32 is added.

In step S218 in FIG. 10, the increase and decrease control unit 44 executes step S220 in a case where the job of the pattern 2 is executed and the job of the pattern 3 is not executed in FIG. 5, in the unit period t. In a case where the job of the pattern 3 in FIG. 5 is being executed in the unit period t, the increase and decrease control unit 44 executes step S224.

In step S220, the increase and decrease control unit 44 executes the addition determination (2) of the CPU core 32. For example, in a case where a remaining addable number, which is a total number of units of the CPU core 32 which is addable to the remaining unit periods tn to tN including the unit period tn, is equal to or larger than the number of currently added extension CPU cores+1, the increase and decrease control unit 44 determines that the CPU core 32 is addable.

In order to calculate the remaining addable number, the increase and decrease control unit 44 first calculates a total number (an added number) of units of the CPU core 32 added before the unit period tn. The increase and decrease control unit 44 sets a number obtained by subtracting the added number from the total number (the upper limit value) of units of the CPU core 32 which is addable to each unit period t, as the remaining addable number.

Next, in step S222, in a case where the addition determination (2) in step S220 is true, the increase and decrease control unit 44 determines that the CPU core 32 is addable, and executes step S224. In a case where the addition determination (2) in step S220 is false, the increase and decrease control unit 44 ends the process illustrated in FIGS. 9 and 10.

In step S224, the increase and decrease control unit 44 issues, to the CPU control unit 46, an instruction to add one CPU core 32. For example, in the case where the job having the pattern 3 is not executed and the job having the pattern 2 is executed, and in a case where the remaining addable number is equal to or more than the number of currently added extension CPU cores+1, one CPU core 32 is added. In a case where the job having the pattern 3 is being executed, one CPU core 32 is added without executing the addition determination of the CPU core 32.

Next, in step S226, the increase and decrease control unit 44 calculates the number of addable CPU cores 32 (for example, the new average number of addable resources) in each of the subsequent unit periods to +1 to tN, and ends the process illustrated in FIGS. 9 and 10. For example, the calculation of the average number of addable resources for the CPU core 32 is executed by the scheduling unit 48 that receives an instruction from the increase and decrease control unit 44. An example of the calculation by the scheduling unit 48 is illustrated in FIG. 11.

FIG. 11 illustrates an example of a process of calculating an average number of addable resources executed by the scheduling unit 48 in FIG. 4. For example, FIG. 11 illustrates an example of a resource management apparatus control method and a resource management program. The process in FIG. 11 is executed by being called from the increase and decrease control unit 44, in step S104 in FIG. 8 and step S226 in FIG. 10.

First, in step S302, the scheduling unit 48 determines whether or not the execution period T starts (for example, whether or not the unit period t1 starts). In a case where the execution period T starts, the scheduling unit 48 executes step S304, and in a case where the execution period T does not start, the scheduling unit 48 executes step S308. Since step S308 is called and executed in step S226 in FIG. 10, step S308 is executed in a case where the CPU core 32 is added in the pattern 2 or the pattern 3.

In step S304, the scheduling unit 48 acquires a total number (designated by the user) of units of the CPU core 32 which is addable to the execution period T (each unit period t). Next, in step S306, the scheduling unit 48 divides the total number of units by the number N of the unit periods t1 to tN to calculate an average number of addable resources, which is an average of the number of units of the CPU core 32 which is addable to each of the unit periods t1 to tN. The scheduling unit 48 notifies the increase and decrease control unit 44 of the calculated average number of addable resources, and ends the process illustrated in FIG. 11.

In step S308, the scheduling unit 48 calculates a total number (a remaining addable number) of units of the CPU core 32 which is addable to the remaining unit periods tn+1 to tN after the unit period tn. For example, the scheduling unit 48 calculates the remaining addable number by subtracting the added number, which is the total number of units of the CPU core 32 added before the unit period tn, from the total number (the upper limit value) of units of the CPU core 32 which is addable to the execution period T (each unit period t).

Next, in step S310, the scheduling unit 48 divides the remaining addable number by the number of the remaining unit periods tn+1 to tN so as to calculate an average number of addable resources, which is an average of the number of CPU cores 32 which are addable to each of the unit periods tn+1 to tN. The scheduling unit 48 notifies the increase and decrease control unit 44 of the calculated average number of addable resources, and ends the process illustrated in FIG. 11.

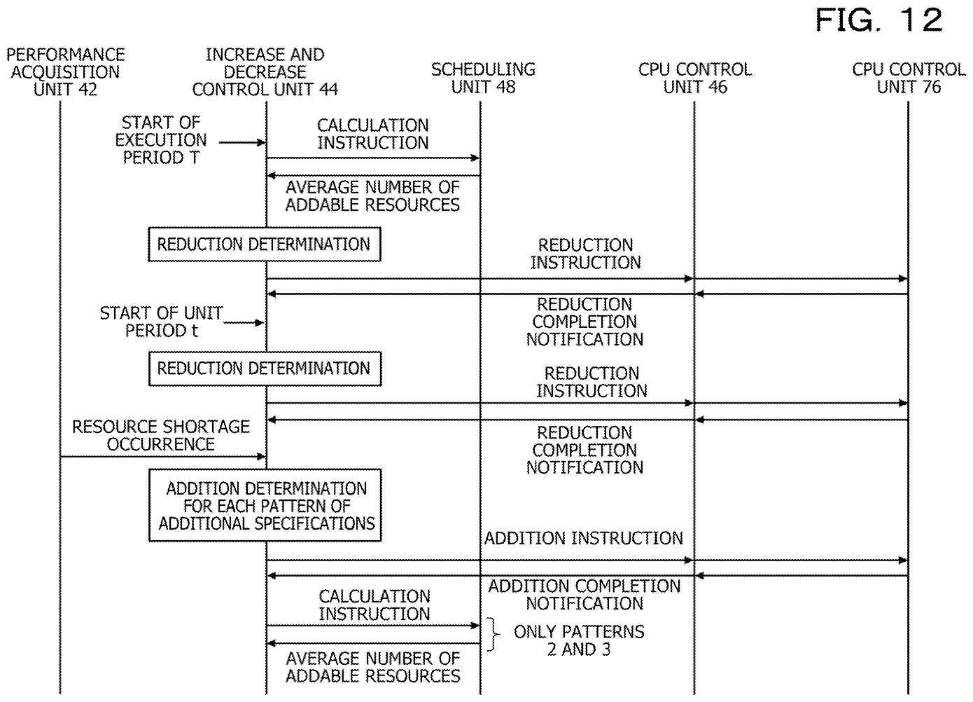

FIG. 12 illustrates an example of an operation of the CPU core 32 that operates as the resource management apparatus in FIG. 4. For example, FIG. 12 illustrates an example of an operation executed by a control method for a resource management apparatus and an operation performed by a resource management program. For example, based on a call made by a timer (not illustrated), the increase and decrease control unit 44 detects a start of the execution period T and issues, to the scheduling unit 48, an instruction to calculate an average number of addable resources, which is the number of addable CPU cores 32 in each unit period t. The scheduling unit 48 notifies the increase and decrease control unit 44 of the average number of addable resources obtained by the calculation. After that, the increase and decrease control unit 44 determines whether or not to add the CPU core 32 when a resource shortage occurs, based on the average number of addable resources and the pattern of the additional specification (FIG. 5) designated for each job.

At the start of the execution period T and the start of the unit period t, the increase and decrease control unit 44 determines whether or not the CPU core 32 being added may be reduced. In a case where the number of CPU cores 32 may be reduced, the increase and decrease control unit 44 instructs the CPU control unit 76 of the service processor 700 to reduce the number of CPU cores 32 via the CPU control unit 46. After reducing the designated number of CPU cores 32, the CPU control unit 76 issues a reduction completion notification to the increase and decrease control unit 44 via the CPU control unit 46.

In a case where the increase and decrease control unit 44 receives the notification of the resource shortage from the performance acquisition unit 42, the increase and decrease control unit 44 executes addition determination of whether or not to add the CPU core 32 as illustrated in FIGS. 9 and 10, for each pattern of the additional specification illustrated in FIG. 5. In a case where it is determined that the CPU core 32 is added, the increase and decrease control unit 44 issues an addition instruction to the CPU control unit 76 of the service processor 700 via the CPU control unit 46. After adding one CPU core 32, the CPU control unit 76 issues an addition completion notification to the increase and decrease control unit 44 via the CPU control unit 46.

In a case where the resource shortage occurs and the CPU core 32 is added during the execution of the job for which the pattern 2 or the pattern 3 is designated in each unit period t, the increase and decrease control unit 44 issues, to the scheduling unit 48, an instruction to calculate an average number of addable resources in the subsequent unit period t. The scheduling unit 48 notifies the increase and decrease control unit 44 of the average number of addable resources obtained by the calculation.

As described above, also in the embodiment illustrated in FIGS. 4 to 12, it is possible to obtain the same effect as those obtained in the embodiment illustrated in FIGS. 1 and 2. For example, in a case where the CPU resource for executing a job for which the pattern 1 is designated is insufficient, the CPU core 32 may be added to the unit period t within a range not exceeding an upper limit of a total number of units of the extension CPU core 32 which is usable in the execution period T. Thus, it is possible to add the CPU core 32 when the resource is insufficient in the subsequent unit period t and to improve efficiency of executing the job.

In this embodiment, in a case where the CPU resource for executing a job for which the pattern 2 or the pattern 3 is designated is insufficient, the CPU core 32 is added regardless of a decrease in an average number of addable resources in the subsequent unit period t. Thus, it is possible to quickly complete the upper process. For example, in the unit period t2 in FIG. 6, it is possible to suppress the delay of the job as indicated by the hatched frame in the unit period t2 in FIG. 2. At this time, since the process of adding the CPU core 32 may be executed without exceeding the upper limit of the total number of units of the CPU core 32 which is addable to each unit period t, it is possible to suppress the additional charge from exceeding an upper limit while improving execution efficiency of the job.

In a case where a job for which the pattern 3 in which a processing speed is prioritized is designated is executed, it is possible to improve the processing speed of the job by adding the CPU cores 32 exceeding the upper limit of the total number of units of the CPU core 32 which is addable in each unit period t. When the job for which the pattern 2 or the pattern 3 is designated is submitted, it is possible to selectively execute a job for suppressing an additional charge and a job for prioritizing a processing speed. For example, it is possible to selectively use, for each job, whether priority is given to a processing cost of the job or processing performance of the job.

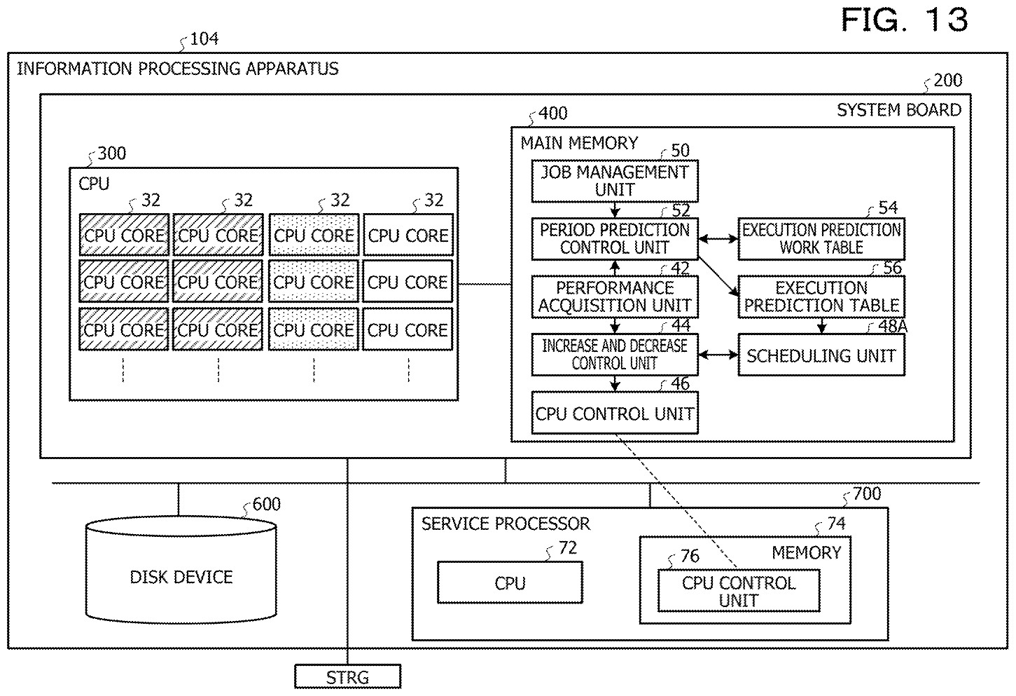

FIG. 13 illustrates an example of a system including a resource management apparatus according to still another embodiment. Components similar to or the same as those illustrated in FIG. 4 are denoted by the same reference numerals and a detailed description thereof will be omitted herein. For example, an information processing apparatus 104 illustrated in FIG. 13 is a system such as a server or a mainframe. A configuration and a function of the information processing apparatus 104 have the same manner as the configuration and the function of the information processing apparatus 102 in FIG. 4 except that a function realized by a resource management program stored in the main memory 400 is different. The resource management program may be stored in the recording medium STRG such as a USB memory coupled to the information processing apparatus 104 and transferred from the recording medium STRG to the main memory 400.

At least one of the CPU cores 32 executes the resource management program stored in the main memory 400 to implement functions of the performance acquisition unit 42, the increase and decrease control unit 44, the CPU control unit 46, a scheduling unit 48A, a job management unit 50, and a period prediction control unit 52. The CPU core 32 that implements the functions of the performance acquisition unit 42, the increase and decrease control unit 44, the CPU control unit 46, the scheduling unit 48A, the job management unit 50, and the period prediction control unit 52 is an example of a resource management apparatus.

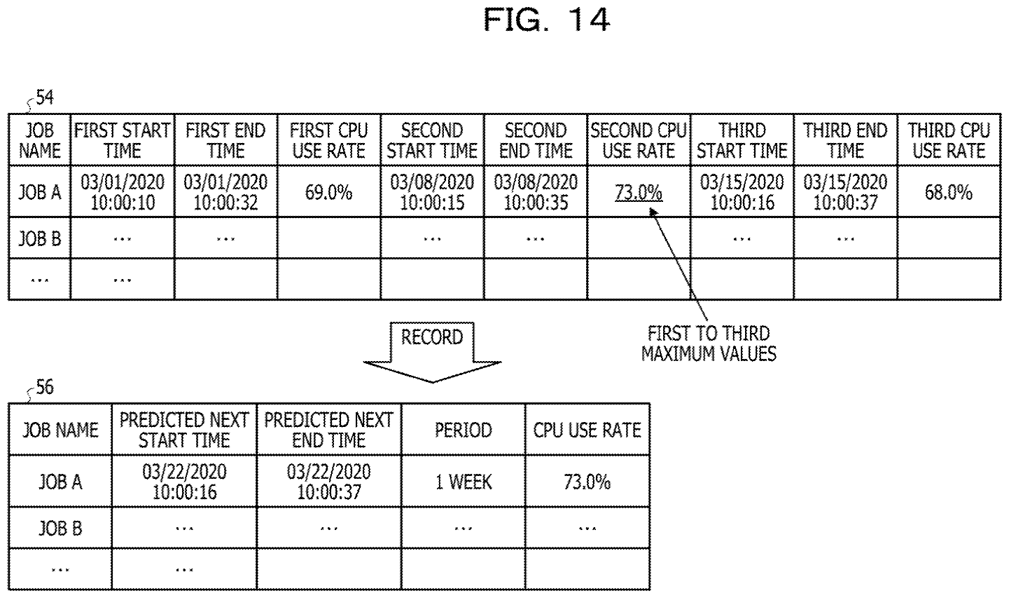

Areas of an execution prediction work table 54 and an execution prediction table 56 are allocated to the main memory 400, The execution prediction work table 54 and the execution prediction table 56 may be allocated to a storage area other than the main memory 400. Examples of the execution prediction work table 54 and the execution prediction table 56 are illustrated in FIG. 14. Information stored in the execution prediction work table 54 is an example of first history information.

The job management unit 50 is a scheduler that manages submission of a job to the CPU 300, and notifies the period prediction control unit 52 of a start time and an end time of the submitted job and a use rate of the added CPU core 32 (for example, a used extension CPU) every time the job is ended.

The period prediction control unit 52 stores the start time and the end time of the job having the pattern 2 or the pattern 3 notified by the job management unit 50 and the use rate of the extension CPU in use notified by the performance acquisition unit 42, in the execution prediction work table 54. In a case where a job having an identical job name is executed a predetermined number of preset times, the period prediction control unit 52 determines whether or not the job has periodicity.

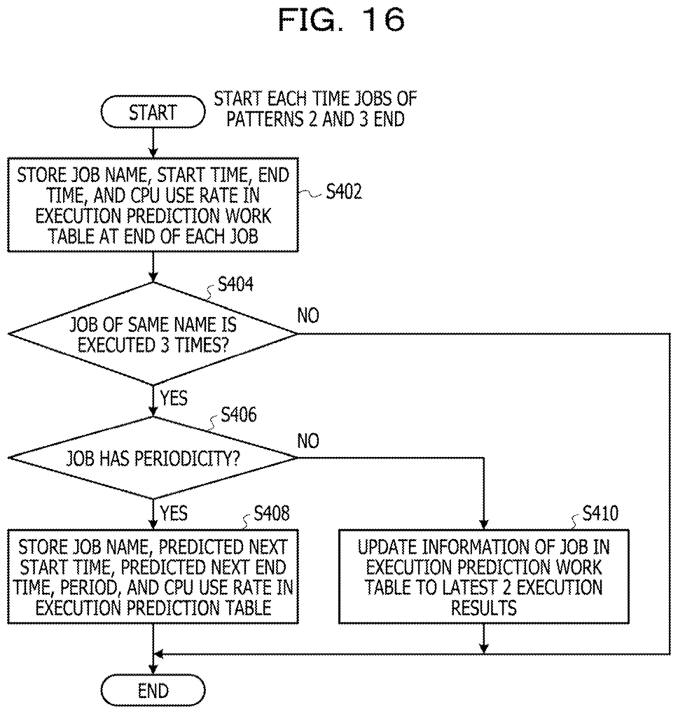

The period prediction control unit 52 stores a predicted next start time and a predicted next end time of the job having periodicity, a predicted value of an execution period of the job, and a predicted value of a use rate of the CPU core 32 that executes the job, in the execution prediction table 56. On the other hand, in a case where the job has no periodicity, the period prediction control unit 52 updates information of the job having no periodicity stored in the execution prediction work table 54 to the latest information. An example of the operation of the period prediction control unit 52 is illustrated in FIG. 16.

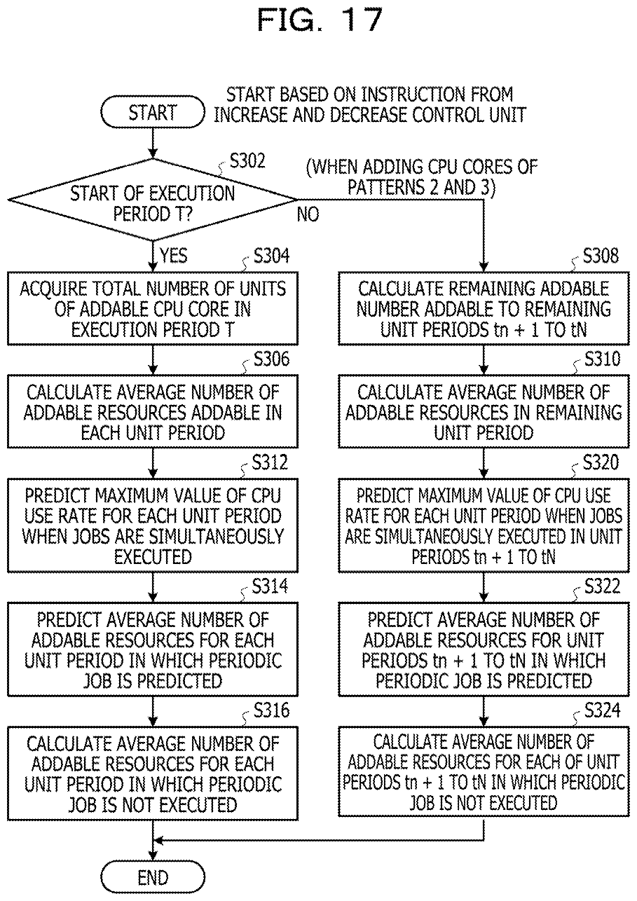

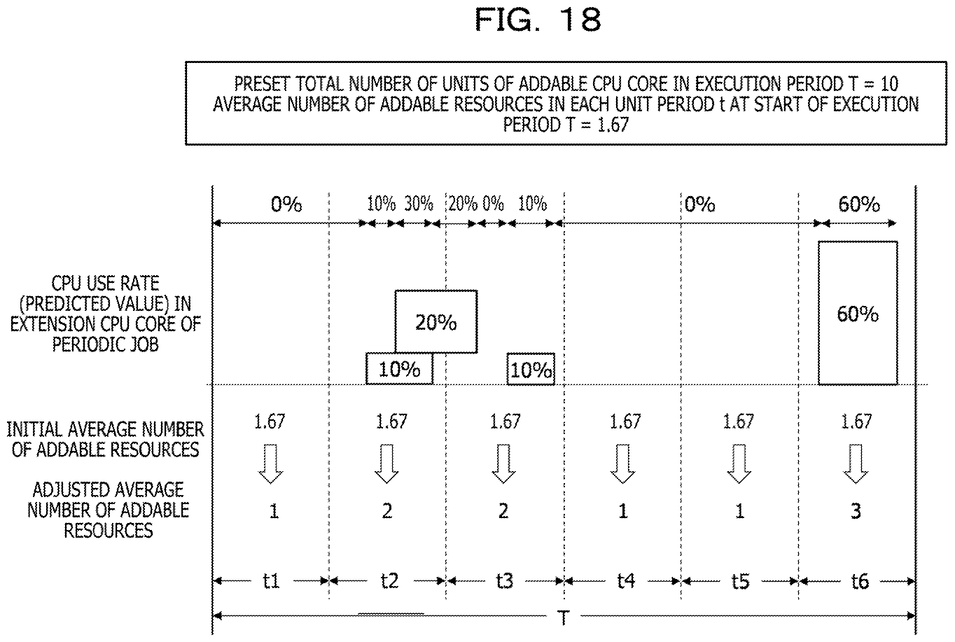

At a start of the execution period T, the scheduling unit 48A calculates the maximum value (a predicted value) of the CPU use rate for each unit period t for the job having the pattern 2 or the pattern 3. Based on the information held in the execution prediction table 56, the scheduling unit 48A calculates an average number of addable resources of the CPU core 32 for each unit period t in which the periodic job having the pattern 2 or the pattern 3 is executed. Based on the calculation result of the number of the addable CPU cores 32 for each unit period t in which the periodic job is executed, the scheduling unit 48A calculates the average number of addable resources of the CPU core 32 for each other unit period t in which the periodic job is not executed. An example of the operation of the scheduling unit 48A is illustrated in FIGS. 17 and 18.

FIG. 14 is an explanatory diagram illustrating an example of the execution prediction work table 54 and the execution prediction table 56 in FIG. 13. The execution prediction work table 54 has, for each job, an entry for storing a start time, an end time, and a CPU use rate of a job having the pattern 2 or the pattern 3 executed a plurality of times. In this embodiment, results of executing jobs 3 times are stored in the execution prediction work table 54 for each job, and results of executing jobs 2 or more times may be stored.

For example, in a case where periodicity is not detected in results of executing identical jobs (for example, a job A) 3 consecutive times, based on information stored in the execution prediction work table 54, the period prediction control unit 52 updates the information stored in the execution prediction work table 54. For example, the period prediction control unit 52 replaces a second execution result with a first execution result, and replaces a third execution result with the second execution result. The period prediction control unit 52 stores an execution result of the job which is newly executed, in the execution prediction work table 54, as the third execution result. As described above, in a case where the job has no periodicity, the period prediction control unit 52 updates the contents held in the execution prediction work table 54 with the latest results of executing the job 3 times.

On the other hand, the execution prediction table 56 has, for each job, an entry for storing a predicted next start time, a predicted next end time, a predicted value of a period in which the job is executed, and a predicted value of a CPU use rate of the job for which periodicity is detected. FIG. 14 illustrates an example of information stored in the execution prediction table 56 in a case where the period prediction control unit 52 detects that the job A has periodicity. The period prediction control unit 52 stores a predicted next start time and a predicted next end time calculated based on an execution period of the detected job (in this example, 1 week) together with an execution period of the job, in the execution prediction table 56. The period prediction control unit 52 stores the highest CPU use rate (73% in this example) among the execution results of the job A stored in the execution prediction work table 54, in the execution prediction table 56.

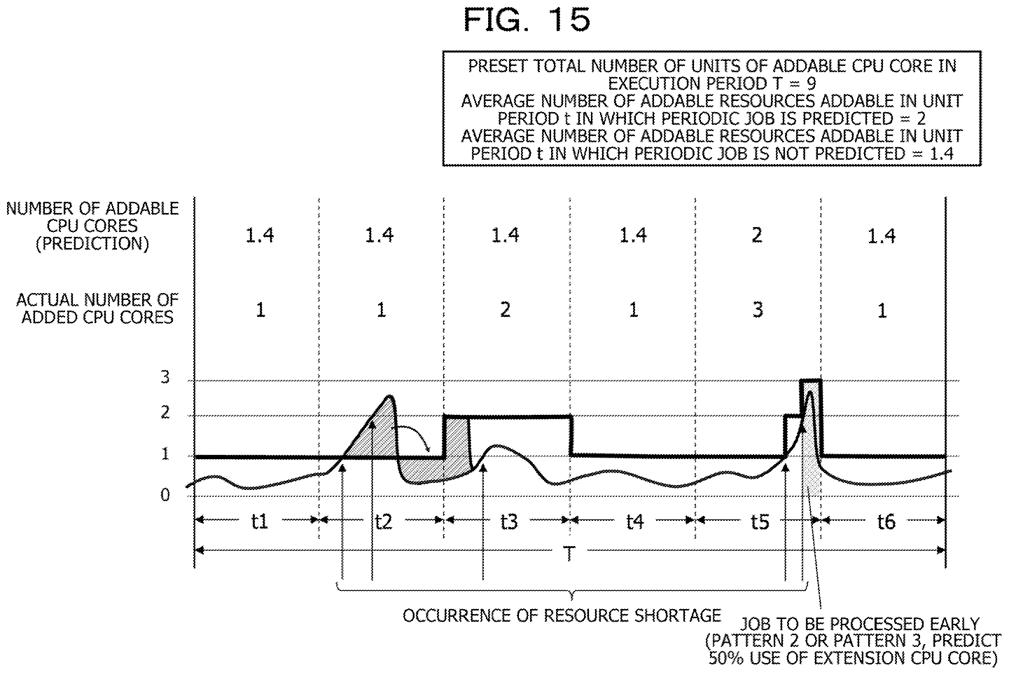

FIG. 15 illustrates an example of a process of adding the CPU core 32 by the increase and decrease control unit 44 in FIG. 13. A detailed description of an operation having the same manner as illustrated in FIGS. 2 and 6 to 7 will be omitted herein. An example of a process executed by the increase and decrease control unit 44 has the same manner as the process illustrated in FIGS. 8 to 10 except that a method of determining addition of the CPU core 32 is different. For example, FIG. 15 illustrates an example of an operation executed by a control method for a resource management apparatus and an operation performed by a resource management program.

The number of unit periods t (t1 to t5) included in the execution period T and the total number (9) of units of the CPU core 32 which is addable to the execution period T set in advance are the same as those in FIG. 2. Thus, the average number of addable resources, which is an average number of CPU cores 32 which are addable to each unit period t, is 1.5 at a start of the execution period T. Hereinafter, the number of CPU cores 32 added in each unit period t (for example, the number of extension CPU cores 32 to be used) is also referred to as the number of additional resources.

Before the job illustrated in FIG. 15 is executed, the period prediction control unit 52 detects a job of the pattern 2 or the pattern 3 having periodicity based on the information stored in the execution prediction work table 54, and stores information on the job having periodicity in the execution prediction table 56. Based on the information stored in the execution prediction table 56, the scheduling unit 48A predicts that the job having periodicity with a CPU use rate of 50% (0.5 for the number of added CPU cores 32) will be executed in the unit period t5.

Before the job illustrated in FIG. 15 is executed, the scheduling unit 48A sets the number of addable CPU cores 32 in the unit period t5, to 2 obtained by adding 0.5 to the average number (1.5) of addable resources. The scheduling unit 48A obtains the number (1.4) of addable CPU cores 32 in another unit period t by dividing 7 obtained by subtracting 2 from the total number (9) of units of the CPU core 32 which is addable in the execution period T by the number (5) of the other unit period t in which a job having periodicity is not executed.

As described above, in this embodiment, the average numbers of addable resources are different from each other between the unit period t in which the job of the pattern 2 or the pattern 3 having periodicity is predicted to be executed and the other unit period t Thus, the number of CPU cores 32 which are addable to the unit period t in which the job of the pattern 2 or the pattern 3 having periodicity is predicted to be executed may be increased more than the number of CPU cores 32 which are addable to the other unit period t.

As a result, for example, it is possible to further improve processing efficiency of the job of the pattern 2 or the pattern 3 to be processed early. At this time, since the number of CPU cores 32 which are addable to the other unit period t decreases, it is possible to improve efficiency of processing the job of the pattern 2 without increasing the total number of units of the CPU core 32 which is addable to the execution period T. It is possible to improve efficiency of processing the job of the pattern 3 while the number of units exceeding the total number of units is minimized.

In FIG. 15, in the middle of the unit period t2, the increase and decrease control unit 44 determines that, due to an increase in the load amount of job, it is not sufficient to use only one extension CPU core 32 (occurrence of a resource shortage). In a case where the number of extension CPU cores 32 to be used is set to 2, the increase and decrease control unit 44 determines that the remaining number (6) of units of the arithmetic operation resource 12 which is addable to the remaining unit periods t3 to t6 is smaller than the total number (6.2) of the average number of addable resources in the remaining unit periods t3 to t6. Thus, the increase and decrease control unit 44 maintains the number of used extension CPU cores 32 to be one.

In the unit period t3, in the case where the number of used extension CPU cores 32 is 2, the increase and decrease control unit 44 determines that the remaining number (5) of units of the arithmetic operation resource 12 which is addable to the unit periods t4 to t6 is larger than the total number (4.8) of the average numbers of addable resources in the unit periods t4 to t6. Thus, the increase and decrease control unit 44 determines to use the two extension CPU cores 32.

In the unit period t5, the increase and decrease control unit 44 increases the number of extension CPU cores 32 to be used, up to addable two. In a case where the load amount of the job having the pattern 2 is further increased, it is determined that the total number (7) of units of the arithmetic operation resource 12 used before the unit period t5 and the number (1) of units of the arithmetic operation resource 12 scheduled to be added is equal to or smaller than the upper limit (9) of the total number of the periods T. Thus, the increase and decrease control unit 44 determines to further add one CPU core 32 and to use the three extension CPU cores 32. In the case where the job of pattern 3 is being executed, the increase and decrease control unit 44 adds one CPU core 32 each time a resource shortage occurs.

FIG. 16 is a flowchart illustrating an example of an operation of the period prediction control unit 52 in FIG. 13. For example, FIG. 16 illustrates an example of a resource management apparatus control method and a resource management program. FIG. 16 is started every time a job of the pattern 2 or the pattern 3 illustrated in FIG. 5 is ended.

First, in step S402, the period prediction control unit 52 stores a job name notified by the job management unit 50, a start time and an end time of the job, and a CPU use rate notified by the performance acquisition unit 42, in the execution prediction work table 54.

Next, in a case where the job having the same name is executed 3 times in step S404, the period prediction control unit 52 executes step S406, and in a case where the job having the same name is not executed 3 times, the period prediction control unit 52 ends the process illustrated in FIG. 16. For example, in a case where execution results for 3 times of the job are stored in one entry of the execution prediction work table 54, the period prediction control unit 52 executes step S406.

In step S406, in a case of detecting that the job has periodicity based on the information stored in the execution prediction work table 54, the period prediction control unit 52 executes step S408, and in a case where the job does not have periodicity, the period prediction control unit 52 executes step S410. The period prediction control unit 52 determines that the job has periodicity in a case where deviation of the start time of the job falls within a predetermined range and deviation of the execution time of the job falls within a predetermined range. For example, in a case where a difference between the start times of the jobs 3 times falls within a predetermined time range set in advance or a time range designated by the user and a difference between the execution times of the jobs 3 times falls within a time obtained by multiplying the execution times by any ratio, the period prediction control unit 52 determines that the job has periodicity.

In step S408, the period prediction control unit 52 determines a job name, a predicted next start time and a predicted next end time of the job, a predicted value of the period of the job, and a predicted value of the CPU use rate based on the results of executing the job 3 times. The period prediction control unit 52 stores the determined job name, the predicted next start time and the predicted next end time of the job, the predicted value of the period of the job, and the predicted value of the CPU use rate in the execution prediction table 56, and ends the process illustrated in FIG. 16. At this time, the period prediction control unit 52 sets the maximum value of the CPU use rate of the execution results 3 times as the predicted value of the CPU use rate so that the CPU resource is not insufficient at a time of the next execution of the job.

In step S410, the period prediction control unit 52 updates information of the job in the execution prediction work table 54 to the latest two execution results, and ends the process illustrated in FIG. 16. For example, the period prediction control unit 52 sets second information as first information and sets third information as the second information in the execution prediction work table 54.

FIG. 17 illustrates an example of a process of calculating the number of addable CPU cores 32, executed by the scheduling unit 48A in FIG. 13. Processes similar to or the same as those illustrated in FIG. 11 are denoted by the same reference numerals and a detailed description thereof will be omitted herein. For example, FIG. 17 illustrates an example of a resource management apparatus control method and a resource management program The process in FIG. 17 is executed by being called from the increase and decrease control unit 44, in step S104 in FIG. 8 and step S226 in FIG. 10, A process of each of steps S302 to S310 in FIG. 17 has the same manner as the process of each of steps S302 to S310 in FIG. 11.

After the completion of step S306, in step S312, the scheduling unit 48A searches the execution prediction table 56 to predict a maximum value of a CPU use rate in a case where the jobs are simultaneously executed in each of the unit periods t1 to tN. Next, in step S314, the scheduling unit 48A adds the maximum value predicted in step S312 to the average number of addable resources acquired in step S306, and calculates the average number of addable resources of the CPU core 32 for each unit period t during which execution of the periodic job is predicted.

Next, in step S316, the scheduling unit 48A subtracts a total number of addable CPU cores 32 for each unit period t predicted in step S314 from the total number of units of the CPU core 32, which is addable to the execution period T, acquired in step S304. The scheduling unit 48A obtains the total number of addable CPU cores 32 in the unit period t during which the periodic execution of the job is not predicted. The scheduling unit 48A obtains the average number of addable resources of the CPU core 32 for each unit period t during which the execution of the periodic job is not predicted by dividing the calculated total number of addable resources by the number of unit periods t during which execution of the periodic job is not predicted. The process illustrated in FIG. 17 ends.

As described above, according to steps S304, S306, S312, S314 and S316, it is possible to increase the CPU resource in the unit period t in which the periodic job is predicted, without exceeding the total number of units of the CPU core 32 which is addable to the execution period T. An example of calculating the average number of addable resources of the CPU core 32 by the scheduling unit 48A will be described with reference to FIG. 18.

On the other hand, after the completion of step S310, in step S320, the scheduling unit 48A searches the execution prediction table 56 to predict the maximum value of the CPU use rate in a case where the jobs are simultaneously executed in each of the remaining unit periods tn+1 to tN. Next, in step S322, the scheduling unit 48A adds the maximum value predicted in step S320 to the average number of addable resources calculated in step S310. The scheduling unit 48A calculates the average number of addable resources of the CPU core 32 for each of the unit periods tn+1 to tN in which execution of the periodic job is predicted.

Next, in step S324, the scheduling unit 48A subtracts the total number of addable CPU cores 32 predicted in step S322 from the total number, acquired in step S308, of units of the CPU core 32 which is addable to each of the remaining unit periods tn+1 to tN. The scheduling unit 48A obtains the total number of addable CPU cores 32 in the remaining unit periods tn+1 to tN in which execution of the periodic job is not predicted. The scheduling unit 48A divides the calculated total number of addable CPU cores 32 by the number of unit periods t in which execution of the periodic job is not predicted, among the remaining unit periods tn+1 to tN. The scheduling unit 48A obtains the average number of addable resources of the CPU core 32 for each unit period t in which execution of the periodic job is not predicted, among the remaining unit periods tn+1 to tN, and then ends the process illustrated in FIG. 17.

As described above, according to steps S308, S310, S320, S322, and S324, it is possible to increase the CPU resource in the unit period t in which the periodic job is predicted without exceeding the total number of CPU cores 32 which are addable to the remaining unit periods to +1 to tN.

FIG. 18 illustrates an example in which the scheduling unit 48A in FIG. 13 adjusts an average number of addable resources in each unit period in a case where there is a periodic job. In the example illustrated in FIG. 18, the execution period T includes 6 unit periods t (t1 to t6). A total number of units of the CPU core 32 which is addable to the execution period T is set to 10, and an average number of addable resources of the CPU core 32 which is addable to each of the unit periods t1 to t6 at a start of the execution period T is 1.67.

In FIG. 18, it is predicted that a periodic job is executed in each of the unit period t2, the unit periods t2 to t3, the unit period t3, and the unit period t6. Predicted values of CPU use rates of the extension CPU cores 32 used for four periodic jobs are respectively 10%, 20%, 10%, and 60%. As the predicted value of the CPU use rate, the CPU use rate stored in the execution prediction table 56 illustrated in FIG. 14 is used. In the unit period t2, since parts of the jobs having the CPU use rates of 10% and 20% are executed in an overlapping manner, the scheduling unit 48A predicts that a maximum value of the CPU use rate of the extension CPU core 32 is 30% which is a sum of the CPU use rates.

In the unit period t2, since the maximum value of the predicted value of the CPU use rate of the periodic job is 30%, the number of additional CPU cores 32 is set to 03. In the unit period t3, since the maximum value of the predicted value of the CPU use rate of the periodic job is 20%, the number of additional CPU cores 32 is set to 02. In the unit period t6, since the maximum value of the predicted value of the CPU use rate of the periodic job is 60%, the number of additional CPU cores 32 is set to 0.6.

In the unit period t2, the scheduling unit 48A rounds up a decimal part of 1.98 obtained by adding 0.3 to an initially set average number (1.67) of addable resources so as to set the number of addable resources of the CPU core 32 to 2. In the unit period t3, the scheduling unit 48A rounds up a decimal part of 1.88 obtained by adding 0.2 to the initially set average number of addable resources of 1.67 so as to set the number of addable CPU cores 32 to 2. In the unit period t6, the scheduling unit 48A rounds up 2.27, which is obtained by adding 0.6 to the initially set average number of addable resources 1.67, so as to set the number of addable CPU cores 32 to 3.

Since a total addable number in the unit periods t2, t3, and t6 during which the periodic job is executed is 7, the number of remaining CPU cores 32 which are allocable to the unit periods t1, t4, and t5 is 3. Thus, the scheduling unit 48A averages the number of remaining CPU cores 32 and sets the average number of addable resources in each of the unit periods t1, t4, and t5 to one. As described above, the adjusted average number of addable resources is 1, 2, 2, 1, 1, or 3 in each of the unit periods t1 to t6 without changing the total number (10) of units of the CPU core 32 which is addable to the execution period T.

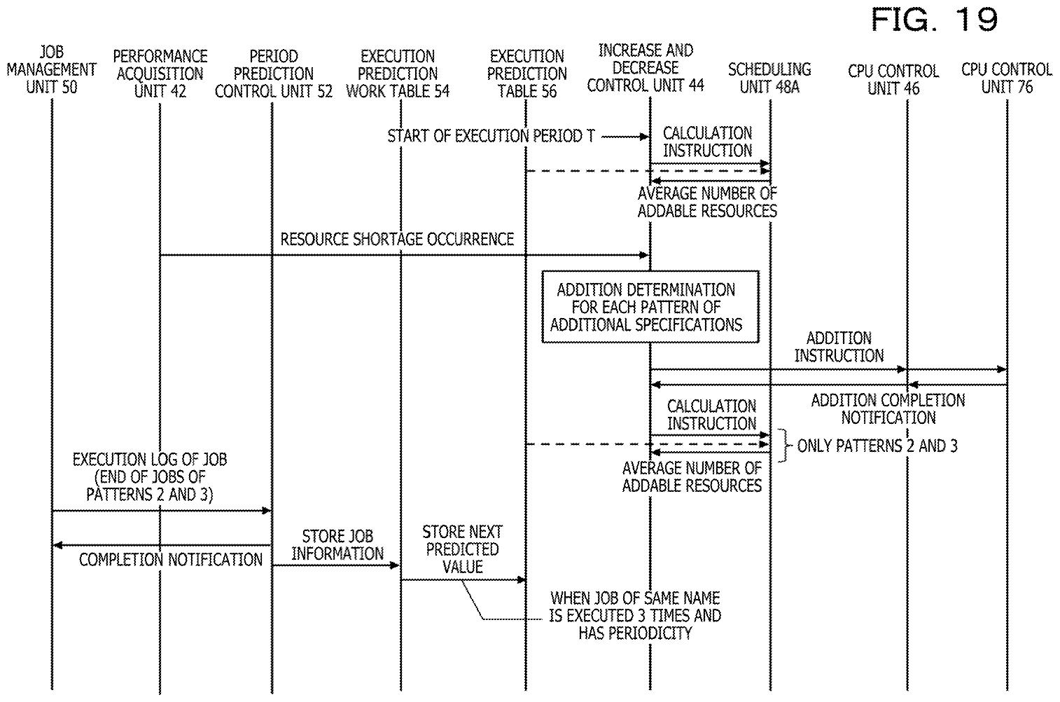

FIG. 19 illustrates an example of an operation of the CPU core 32 that operates as the resource management apparatus in FIG. 13. A detailed description of a process having the same manner as illustrated in FIG. 12 will be omitted herein. For example, FIG. 19 illustrates an example of an operation executed by a control method for a resource management apparatus and an operation performed by a resource management program. The process of reducing the number of CPU cores 32 illustrated in FIG. 12 is also executed in FIG. 19, so a description thereof is not illustrated in FIG. 19. The process of reducing the number of CPU cores 32 is executed at a start of each unit period t (including a start of the execution period T), in the same manner as FIG. 12.

First, at the start of the execution period T, the increase and decrease control unit 44 issues, to the scheduling unit 48A, an instruction to calculate an average number of addable resources, which is the number of addable CPU cores 32 in each unit period t. Based on the calculation instruction from the increase and decrease control unit 44, the scheduling unit 48A refers to information on the predicted execution date and time for each job and the CPU use rate at that time held in the execution prediction table 56 (FIG. 14). Based on the referred information, the scheduling unit 48A calculates (adjusts) the average number of addable resources of the CPU core 32 for each unit period t as described with reference to FIG. 18, and notifies the increase and decrease control unit 44 of the calculation result.

In a case where the performance acquisition unit 42 detects that the CPU resource is insufficient during the execution of the job in each of the unit periods t, the increase and decrease control unit 44 executes addition determination on the CPU core 32 for each pattern of additional specifications illustrated in FIG. 5. In a case where the addition of the CPU core 32 is determined, the increase and decrease control unit 44 instructs the CPU control unit 46 to add the CPU core 32. The CPU control unit 46 adds the CPU core 32 via the CPU control unit 76 of the service processor 700, based on the instruction from the increase and decrease control unit 44.

In a case where the resource shortage occurs and the CPU core 32 is added during the execution of the job for which the pattern 2 or the pattern 3 is designated in each unit period t, the increase and decrease control unit 44 issues, to the scheduling unit 48, an instruction to recalculate the average number of addable resources. The scheduling unit 48A calculates the average number of addable resources of the CPU core 32 for each unit period t based on the information held in the execution prediction table 56, and notifies the increase and decrease control unit 44 of the calculation result.

On the other hand, when the job of the pattern 2 or the pattern 3 is ended, the job management unit 50 notifies the period prediction control unit 52 of, for example, a job name, a start time and an end time of the job, and a CPU use rate as job information in an execution log. The period prediction control unit 52 stores the job information received from the job management unit 50 in the execution prediction work table 54. As described with reference to FIG. 16, in a case where a job of the same name is executed 3 times and the job has periodicity, the period prediction control unit 52 stores next predicted values (a next start prediction time, a next end prediction time, a period, and a CPU use rate) in the execution prediction table 56.

As described above, also in the embodiment described with reference to FIGS. 13 to 19, it is possible to obtain the same effects as those obtained in the embodiment described with reference to FIGS. 1 to 12. For example, in a case where a job for which the pattern 1 or the pattern 2 is designated is executed, the CPU core 32 may be added to the unit period t within a range not exceeding an upper limit of a total number of units of the extension CPU core 32 which is usable in the execution period T. Thus, it is possible to add the CPU core 32 when the resource is insufficient in the subsequent unit period t and to improve efficiency of executing the job.

In this embodiment, the number of CPU cores 32 which are addable to the unit period t in which the job having periodicity is predicted to be executed may be increased more than the number of CPU cores 32 which are addable to the other unit period t. As a result, for example, it is possible to further improve processing efficiency of the job of the pattern 2 or the pattern 3 to be processed early. At this time, it is possible to improve processing efficiency of the job having the pattern 2 without increasing the total number of units of the CPU core 32 which is addable to the execution period T. It is possible to improve efficiency of processing the job of the pattern 3 while the number of units exceeding the total number of units is minimized.

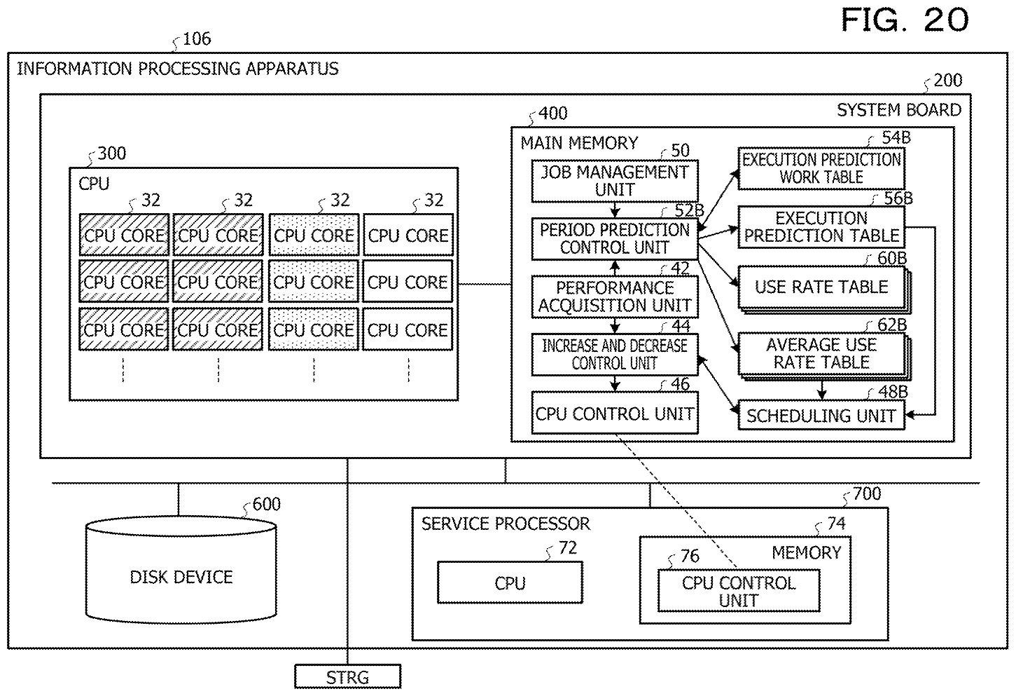

FIG. 20 illustrates an example of a system including a resource management apparatus according to still another embodiment. Components similar to or the same as those illustrated in FIGS. 4 to 13 are denoted by the same reference numerals and a detailed description thereof will be omitted herein. For example, an information processing apparatus 106 illustrated in FIG. 20 is a system such as a server or a mainframe. A configuration and a function of the information processing apparatus 106 have the same manner as the configurations and the functions of the information processing apparatus 102 in FIG. 4 and the information processing apparatus 104 in FIG. 13 except that a function realized by a resource management program stored in the main memory 400 is different.

In this embodiment, at least one of the CPU cores 32 executes a resource management program stored in the main memory 400. When the CPU core 32 executes the resource management program, functions of the performance acquisition unit 42, the increase and decrease control unit 44, the CPU control unit 46, a scheduling unit 48B, the job management unit 50, and a period prediction control unit 528 are realized The CPU core 32 that implements the functions of the performance acquisition unit 42, the increase and decrease control unit 44, the CPU control unit 46, the scheduling unit 48B, the job management unit 50, and the period prediction control unit 528 is an example of a resource management apparatus. The resource management program may be stored in the recording medium STRG such as a USB memory coupled to the information processing apparatus 106 and transferred from the recording medium STRG to the main memory 400.

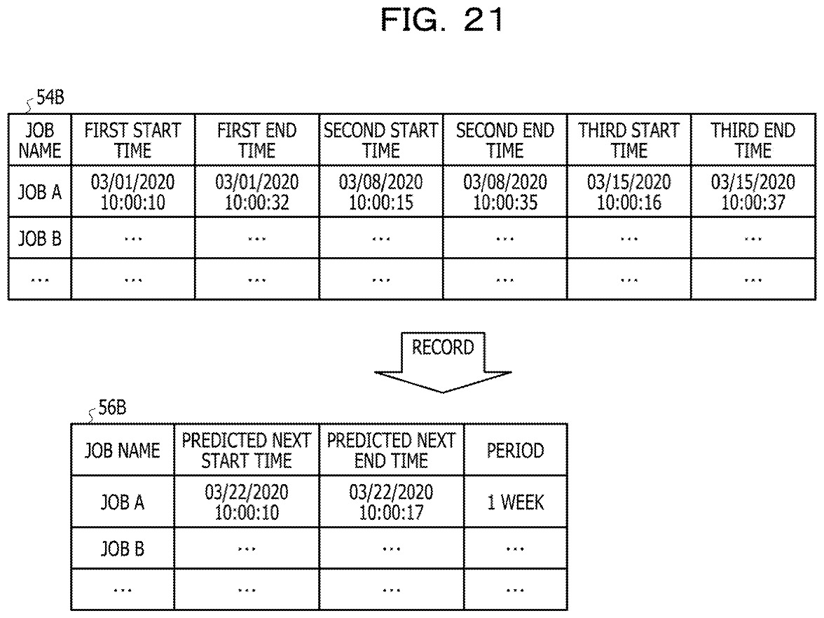

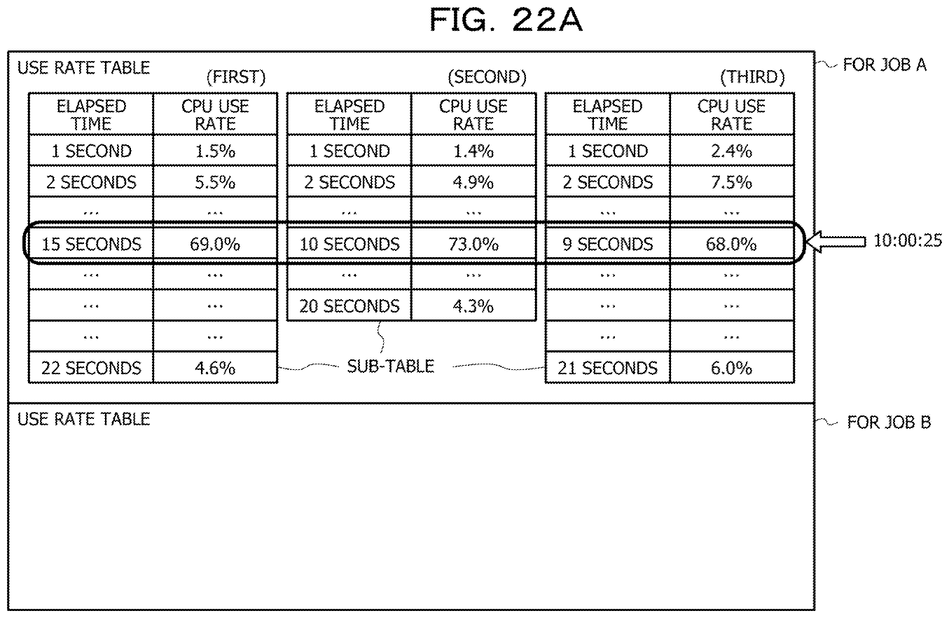

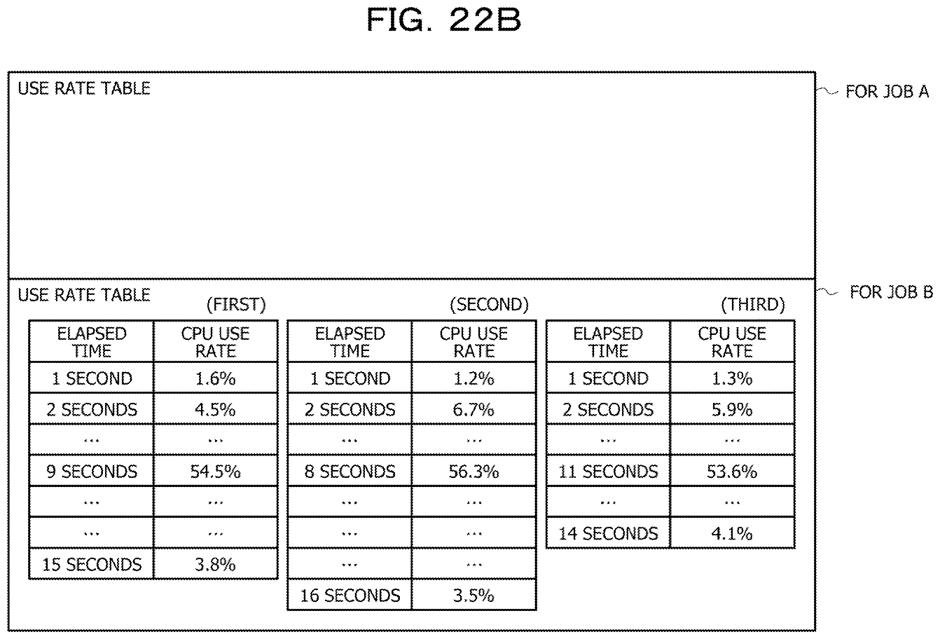

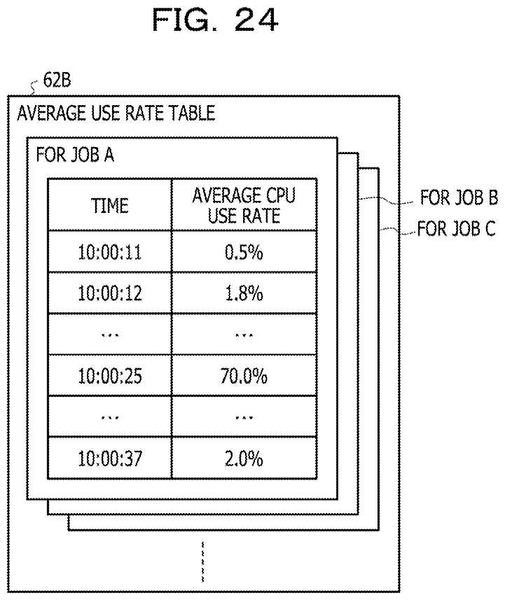

Areas of an execution prediction work table 548, an execution prediction table 568, a use rate table 60B, and an average use rate table 628 are allocated to the main memory 400. The execution prediction work table 548, the execution prediction table 568, the use rate table 60B, and the average use rate table 628 may be allocated to a storage area other than the main memory 400, Examples of the execution prediction work table 54B and the execution prediction table 568 are illustrated in FIG. 21. An example of the use rate table 608 is illustrated in FIGS. 22A and 228, and an example of the average use rate table 628 is illustrated in FIG. 24. Information stored in the execution prediction work table 548 is an example of first history information. Information stored in the use rate table 60B is an example of second history information. Information stored in the average use rate table 628 is an example of third history information.

In the same manner as the period prediction control unit 52 illustrated in FIG. 13, the period prediction control unit 528 has a function of storing information of each job in the execution prediction work table 54 and the execution prediction table 56. The period prediction control unit 52B stores information indicating a temporal change in a CPU use rate of each job in the use rate table 60B and the average use rate table 628, instead of storing the CPU use rate in the execution prediction work table 54 and the execution prediction table 56.

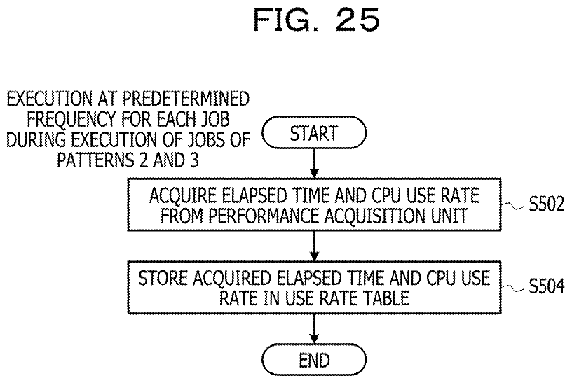

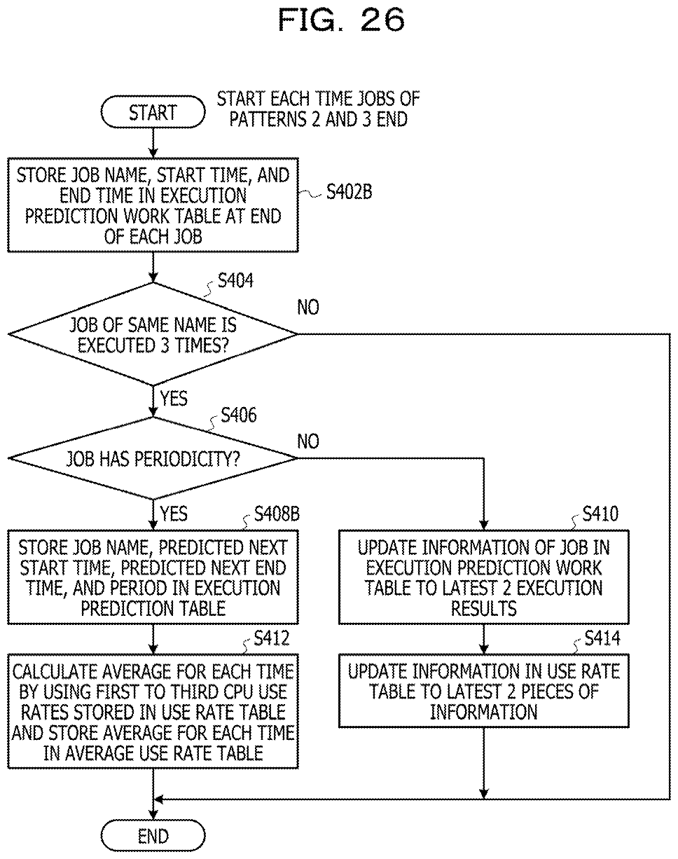

During execution of the job of the pattern 2 or the pattern 3, the period prediction control unit 528 stores the CPU use rate in the use rate table 60B every time a predetermined time elapses. The period prediction control unit 528 stores predicted values of a next start time, a next end time, and a next period for a job determined to have periodicity based on the information stored in the execution prediction work table 54 every time the job is ended, in the execution prediction table 568. For the job determined to have periodicity, the period prediction control unit 528 stores an average value of the CPU use rates for the elapsed times in the average use rate table 62B. An example of an operation of the period prediction control unit 528 is illustrated in FIGS. 25 and 26.

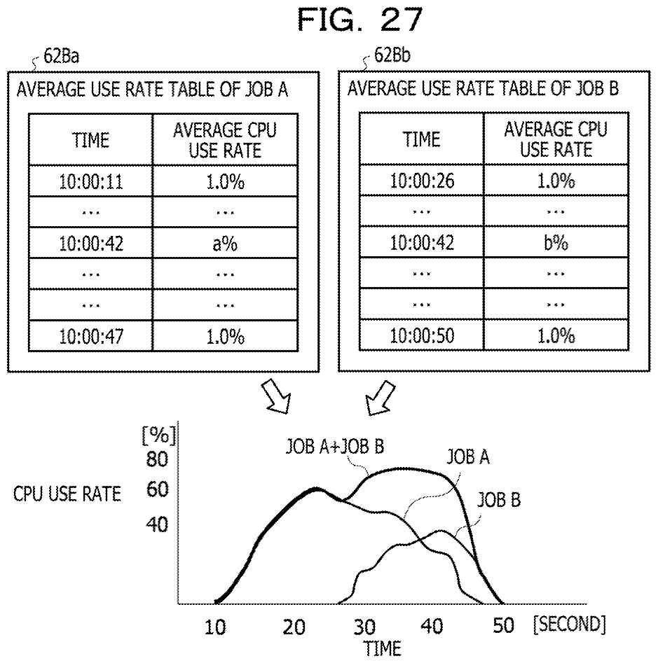

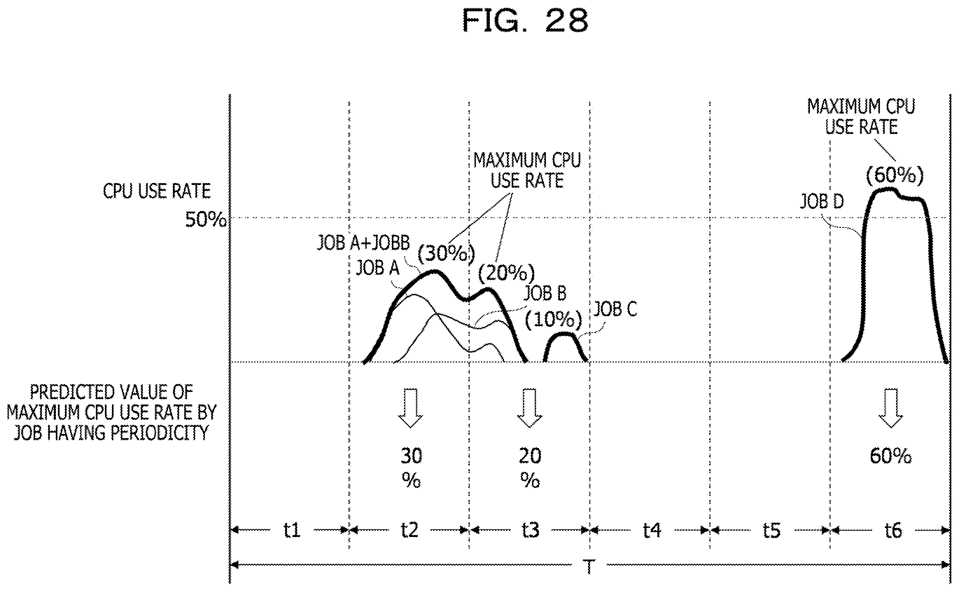

The scheduling unit 488 calculates a change in the use rate of the CPU core 32 in each unit period t, based on information on an execution result for each job held in the execution prediction table 568 and the temporal change in the average CPU use rate for each job held in the average use rate table 62B. The scheduling unit 488 calculates a maximum CPU use rate (a predicted value) in each unit period t based on the change in the use rate of the CPU core 32 in each unit period t. An example of an operation of the scheduling unit 488 is illustrated in FIGS. 27 and 28.

FIG. 21 illustrates an example of the execution prediction work table 54B and the execution prediction table 56B in FIG. 20. The execution prediction work table 548 has the same manner as the execution prediction work table 54 in FIG. 14 except that there is no area for storing a CPU use rate each time. The execution prediction table 568 has the same manner as the execution prediction table 56 in FIG. 14 except that there is no area for storing a CPU use rate.

FIGS. 22A and 228 illustrate an example of the use rate table 608 illustrated in FIG. 20. The use rate table 608 includes a sub-table for each job. The sub-table stores information indicating a change in CPU use rates of a job for a plurality of periods. Each sub-table has a plurality of entries that store the CPU use rate acquired at predetermined time intervals (for example, 1 second) for each elapsed time. The use rate table 608 may not have an area for storing the elapsed time. In this case, the elapsed time is determined based on an identification number of an entry in each sub-table. For example, the use rate table 608 has three sub-tables for each job in the same manner as the number of executions of the job held in the execution prediction work table 54B, and may hold a change in CPU use rates for 3 times of the job.

The elapsed time in each sub-table indicates an elapsed time from a start time of each job (the job A or the job B in FIGS. 22A and 22B). For example, a submission time of the job A instructed by the user is 10 o'clock (10: 80: 00) every day, and an actual start time of each job is shifted for each job according to scheduling management by the job management unit 50. Thus, for example, at time 10: 00: 25, the elapsed time of the first job A is 15 seconds, the elapsed time of the second job A is 10 seconds, and the elapsed time of the third job A is 9 seconds.

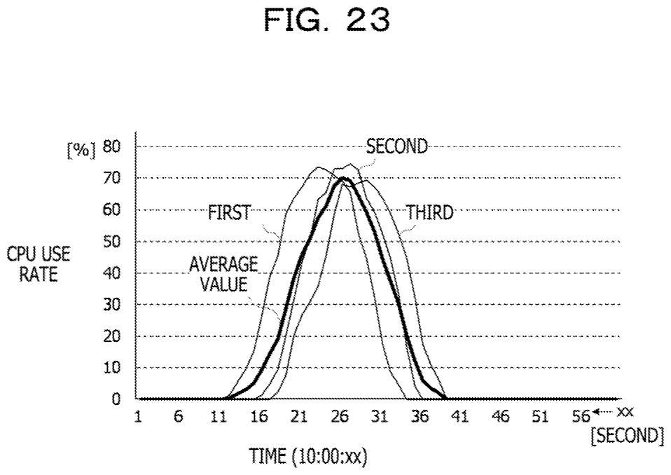

FIG. 23 illustrates an example of a change in CPU use rates stored in the use rate table 608 in FIGS. 22A and 22B. In order to clarify the description, FIG. 23 illustrates a change in the CPU use rates (measured values) stored in the use rate table 60B and an average value calculated by the period prediction control unit 52B, as a graph form. There is a high possibility that a start time and an end time of a job submitted 3 times are different for each job. Thus, the period prediction control unit 52B calculates an average value of CPU use rates for 3 times of the jobs. By calculating the average value of the CPU use rates of the job a plurality of times, the start time and the peak time of the CPU use rate, which vary for each job, may be statistically obtained. Thus, it is possible to improve accuracy of predicting an occurrence time of a maximum CPU use rate of the job to be executed next.

FIG. 24 illustrates an example of the average use rate table 62B in FIG. 20. The average use rate table 62B has a plurality of entries that hold a time and an average CPU use rate at predetermined time intervals (for example, every second). The average CPU use rate stored in the average use rate table 628 is an average value illustrated in FIG. 23 calculated by the period prediction control unit 528.

The time stored in a time area of the average use rate table 628 is obtained by the period prediction control unit 528 adding an elapsed time stored in the use rate table 608 in FIGS. 22A and 228 to a start time stored in the execution prediction work table 548 in FIG. 21.

FIG. 25 illustrates an example of an operation of the period prediction control unit 528 in FIG. 20 during execution of a job of the patterns 2 and 3. For example, FIG. 25 illustrates an example of a resource management apparatus control method and a resource management program. FIG. 25 is executed at a predetermined frequency (for example, every second) for each job during the execution of the job of the pattern 2 or the pattern 3 illustrated in FIG. 5.

First, in step S502, the period prediction control unit 528 acquires an elapsed time from a start of the execution and a CPU use rate of the job, from the performance acquisition unit 42. For example, a frequency of acquiring the elapsed time and the CPU use rate depends on an acquisition condition set in the performance acquisition unit 42. Next, in step S504, the period prediction control unit S213 stores the acquired elapsed time and CPU use rate in the use rate table 60B, and ends the process illustrated in FIG. 25.

FIG. 26 illustrates an example of an operation performed by the period prediction control unit 52B illustrated in FIG. 20 when a job of the patterns 2 and 3 is ended. Operations similar to or the same as those illustrated in FIG. 16 are denoted by the same reference numerals and a detailed description thereof will be omitted herein. For example, FIG. 26 illustrates an example of a resource management apparatus control method and a resource management program. Step S402B has the same manner as step S402 in FIG. 16 except that a CPU use rate is not stored. Each of steps S404 and S406 has the same manner as each of steps S404 and S406 in FIG. 16. Step S4086 has the same manner as step S408 in FIG. 16 except that the CPU use rate is not stored.

After step S4086, in step S412, the period prediction control unit 526 calculates an average value of CPU use rates at respective times by using the CPU use rates of a first job to a third job stored in the use rate table 606 (FIGS. 22A and 22B). The period prediction control unit 52B stores the calculated average value of the CPU use rates in the average use rate table 62B, and ends the process illustrated in FIG. 26.

On the other hand, after step S410, in step S414, in the same manner as step S410, the period prediction control unit 526 updates information in the use rate table 60B to the latest information as in step S410, and ends the process illustrated in FIG. 26. For example, in the use rate table 60B, the period prediction control unit 52B deletes a first sub-table, sets a second sub-table as the first sub-table, and sets a third sub-table as the second sub-table.

FIG. 27 illustrates an example of a method of predicting a CPU use rate from an average CPU use rate of a plurality of periodic jobs by the scheduling unit 48B in FIG. 20. In a case where a plurality of jobs A and B are executed in an overlapping manner, the scheduling unit 488 adds, for each time, average CPU use rates of the jobs A and B held in the average use rate table 62B so as to calculate a CPU use rate (a total value) for each time by the execution of the jobs A and B. An average use rate table 62Ba for the job A and an average use rate table 62Bb for the job B illustrated in FIG. 27 are included in the average use rate table 628 in FIG. 24.

The scheduling unit 488 may use information indicating a temporal change in the CPU use rate of each job executed last time so as to calculate the CPU use rate in a case where the plurality of jobs are executed in an overlapping manner, without using the average CPU use rate of each job. In this case, the use rate table 60B in FIGS. 22A and 22B may store information indicating a change in the CPU use rate 1 time for each job, and the average use rate table 628 is not provided. The scheduling unit 488 calculates the CPU use rate in the case where the plurality of jobs are executed in an overlapping manner by using information indicating a change in the CPU use rate of the job executed last time, held in the use rate table 608.

FIG. 28 illustrates an example of a method of predicting a maximum CPU use rate in each unit period t by the scheduling unit 488 based on the CPU use rate predicted in FIG. 27. For example, FIG. 28 illustrates an example of an operation executed by a control method for a resource management apparatus and an operation performed by a resource management program. The number of unit periods t (t1 to t6) included in the execution period T is identical with that in FIG. 2. Each of the jobs A, B, C, and D is determined to have periodicity by the period prediction control unit 52B.

In FIG. 28, the jobs A and B are executed in an overlapping manner from the unit period t2 to the first half of the unit period t3. The job C is executed alone in the second half of the unit period t3. The job D is executed alone in the unit period t6. Information indicating a change in CPU use rates of each of the periodic jobs A to D illustrated in FIG. 28 is held in the average use rate table 62B.

The scheduling unit 48B calculates the maximum CPU use rate in the unit periods t2, t3, and t6 including the job having periodicity by referring to the information on the CPU use rate at each time of each job held in the average use rate table 62B. For example, the scheduling unit 488 determines that the maximum CPU use rate in the unit period t2 is 30%, the maximum CPU use rate in the unit period t3 is 20%, and the maximum CPU use rate in the unit period t6 is 60%. After that, in the same manner as the operation of the scheduling unit 48A described with reference to FIG. 18, the scheduling unit 48B calculates the number of additional CPU cores 32 in each of the unit periods t2, t3, and t6 to be 0.3, 0.2, and 0.6, based on the calculated maximum CPU use rates.

In the same manner as FIG. 18, the scheduling unit 48B calculates an average number of addable resources which is the number of addable CPU cores 32 in the unit periods t2, t3, and t6 in which the periodic jobs A to D are executed. The scheduling unit 48B excludes a total of the average numbers of addable resources in the unit periods t2, t3, and t6, and calculates the average number of addable resources of the CPU core 32 in the unit periods t1, t4, and t5 in which the periodic jobs A to D are not executed.

As described above, by referring to the information on the CPU use rate for each time of each job, it is possible to predict an occurrence time of the maximum CPU use rate with high accuracy in each unit period t, and to improve accuracy of predicting the addable number of CPU cores 32 in each unit period t. As a result, for example, it is possible to further improve execution efficiency of the job having periodicity without increasing an additional charge.

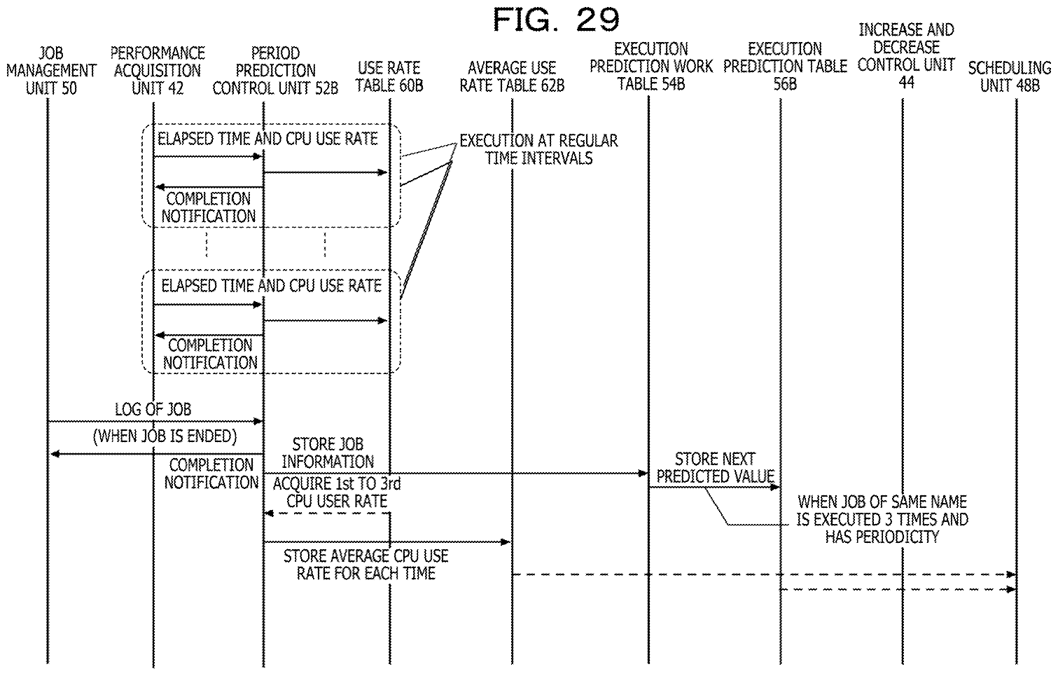

FIG. 29 illustrates an example of an operation of the CPU core 32 that operates as the resource management apparatus in FIG. 20. A detailed description of a process having the same manner as illustrated in FIGS. 12 and 19 will be omitted herein. For example, FIG. 29 illustrates an example of an operation executed by a control method for a resource management apparatus and an operation performed by a resource management program. The process of reducing the number of CPU cores 32 illustrated in FIG. 12 and the process of adding the CPU core 32 when a resource shortage occurs illustrated in FIG. 19 are also executed in FIG. 29, so a description thereof is not illustrated in FIG. 29.

Every time a certain time (for example, 1 second) elapses, the period prediction control unit 528 acquires an elapsed time from a start of execution of a job and a CPU use rate from the performance acquisition unit 42 and stores the acquired information in the use rate table 60B. A completion notification is output to the period prediction control unit 523 and the performance acquisition unit 42. When the job of the pattern 2 or the pattern 3 is ended, the period prediction control unit 52B stores the job information from the job management unit 50 in the execution prediction table 56, and stores a next predicted value of the job having periodicity in the execution prediction table 56, and this operation has the same manner as that in FIG. 19.

In this embodiment, when the job of the pattern 2 or the pattern 3 is ended, the period prediction control unit 52B further calculates an average value of CPU use rates at respective times by using the CPU use rates at the respective elapsed times stored in the use rate table 605. The period prediction control unit 529 stores the calculation result in the average use rate table 629.

As described with reference to FIG. 28, the scheduling unit 488 calculates the average number of addable resources of the CPU core 32 in the unit period t in which the periodic job is executed, and calculates the average number of addable resources in the unit period t in which the periodic job is not executed by using the calculation result. At this time, the scheduling unit 48B refers to the next prediction information of each job having periodicity held in the execution prediction table 56B and the average CPU use rate for each time held in the average use rate table 629.

As described above, also in the embodiment described with reference to FIGS. 20 to 29, it is possible to obtain the same effect as those obtained in the embodiment described with reference to FIGS. 1 to 19. For example, the number of CPU cores 32 which are addable to the unit period t in which the job having periodicity is predicted to be executed may be increased more than the number of CPU cores 32 which are addable to the other unit period t. As a result, for example, it is possible to further improve processing efficiency of the job of the pattern 2 or the pattern 3 to be processed early.

In this embodiment, by calculating the average value of the CPU use rates of the job a plurality of times, the start time and the peak time of the CPU use rate, which vary for each job, may be statistically obtained. Thus, it is possible to improve accuracy of predicting an occurrence time of a maximum CPU use rate of the job to be executed next. By obtaining the maximum value of the CPU use rate in the unit period t in which the job having periodicity is executed based on the highly accurately predicted occurrence time of the maximum CPU use rate, it is possible to improve accuracy of predicting the number of addable CPU cores 32 for each unit period t. As a result, for example, it is possible to further improve execution efficiency of the job having periodicity without increasing an additional charge.

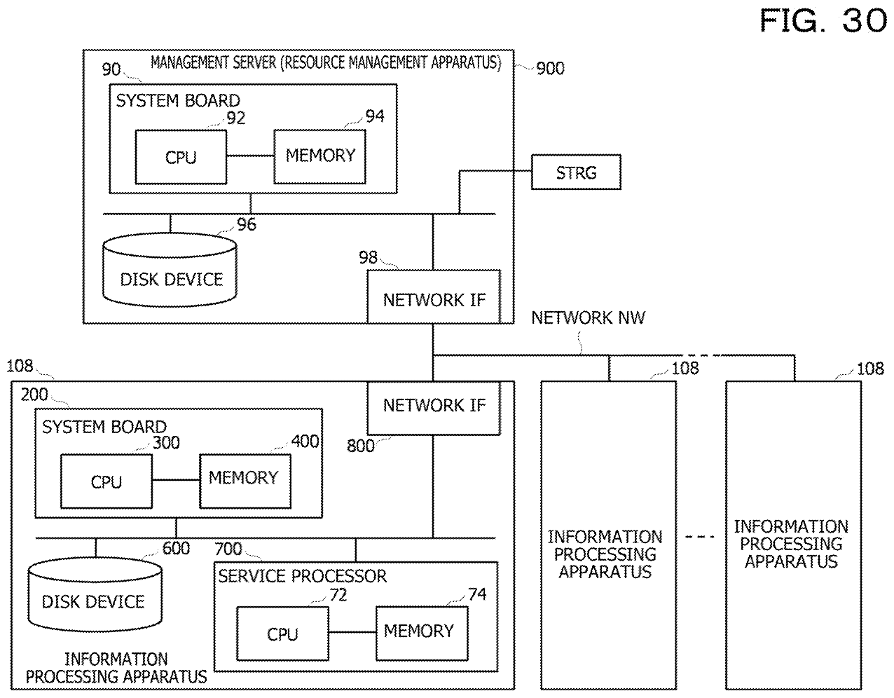

FIG. 30 illustrates an example of a system including a resource management apparatus according to still another embodiment. Components similar to or the same as those illustrated in FIG. 4 are denoted by the same reference numerals and a detailed description thereof will be omitted herein. For example, a system illustrated in FIG. 30 includes a plurality of information processing apparatuses 108 and a management server 900 that is coupled to each information processing apparatuses 108 via a network NW and manages an operation of each information processing apparatuses 108. For example, the system is a cloud system, and the plurality of information processing apparatuses 108 are used for cloud computing.

In the same manner as the information processing apparatus 102 illustrated in FIG. 4, each of the information processing apparatuses 108 includes a system board 200, a disk device 600 and a service processor 700 which are coupled to the system board 200. Each of the information processing apparatuses 108 includes a network interface (IF) 800 that executes communication with the management server 900 via the network NW. The system board 200 includes a CPU 300 including a plurality of CPU cores (not illustrated) and the main memory 400 coupled to the CPU 300. Each CPU core executes an information processing program stored in the main memory 400 based on an instruction from the user of the information processing apparatus 108 to execute a job. Each CPU core in the CPU 300 is an example of an arithmetic operation resource for executing the job.

The management server 900 includes a system board 90 on which a CPU 92 and a memory 94 are mounted, and a disk device 96 and a network interface (IF) 98 that are coupled to the system board 90. The network IF 98 is coupled to the network IF 800 of each information processing apparatus 108 via the network NW, and executes communication with each information processing apparatus 108. The CPU 92 executes a resource management program stored in the memory 94. Thus, the management server 900 functions as the resource management apparatus. The resource management program may be stored in the recording medium STRG such as a USB memory coupled to the management server 900, and may be transferred from the recording medium STRG to the memory 94. Hereinafter, the management server 900 is also referred to as the resource management apparatus 900.

The resource management apparatus 900 allocates a predetermined number of CPU cores among the CPU cores in the CPU 300 of the plurality of information processing apparatuses 108 to execute the job of the user and determines the number of extension CPU cores to be used, which are addable CPU core to execute the job of the user. For example, the resource management apparatus 900 has a function as the resource management apparatus 20 according to the embodiment illustrated in FIGS. 1 to 2, or has a function as the resource management apparatus according to the embodiment illustrated in FIGS. 4 to 12. Alternatively, the resource management apparatus 900 has a function as the resource management apparatus according to the embodiment illustrated in FIGS. 13 to 19, or has a function as the resource management apparatus according to the embodiment illustrated in FIGS. 20 to 29.

Meanwhile, the resource management apparatus 900 does not have the functions of the performance acquisition unit 42 and the job management unit 50 illustrated in FIGS. 13 and 20. The resource management apparatus 900 receives information from a performance acquisition unit (not illustrated) and a job management unit (not illustrated) of each information processing apparatus 108 via the network NW, and realizes the function as the resource management apparatus according to the embodiment described above. Thus, in the cloud system according to the embodiment illustrated in FIG. 30, it is possible to obtain the same effects as those obtained in the embodiment illustrated in FIGS. 1 to 29.

Regarding the embodiments illustrated in FIGS. 1 to 30, the following appendices are further disclosed.

As specifically described above, features and advantages of the embodiments are clarified. This is intended to cover the features and advantages of the embodiments as described above without departing from the spirit and scope of the claims. An ordinary skilled person in the art in the technical field may easily conceive any improvements or modifications. Therefore, there is no intention to limit the scope of the embodiment having the inventive aspect to those described above and it is also possible to rely on appropriate improvements and equivalents included in the range disclosed in the embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A resource management apparatus for adding an arithmetic operation resource to each of a plurality of unit periods included in an execution period for executing a job, the resource management apparatus comprising:
a memory; and
a processor coupled to the memory and configured to:
calculate, in a case where the arithmetic operation resource is insufficient in each of the unit periods, the number of arithmetic operation resources which is the number of the arithmetic operation resources to be added in the unit period within a range not exceeding an upper limit of a total number of the arithmetic operation resources which are addable to each of the plurality of unit periods; and
add the number of arithmetic operation resources calculated by the resource count calculation unit to the unit period.

2. The resource management apparatus according to claim 1,
wherein in a case where the arithmetic operation resource is insufficient in each of the unit periods, the processor calculates the number of arithmetic operation resources to be added to each of the unit periods within a range not exceeding an average number of addable resources obtained by dividing the upper limit of the total number by the number of the unit periods included in the execution period.

3. The resource management apparatus according to claim 1,
wherein the processor
calculates an average number of addable resources which is an average of the number of the arithmetic operation resources addable to a subsequent unit period within a range not exceeding the upper limit of the total number, every time the arithmetic operation resource is added to any one of the unit periods, and
calculates the number of arithmetic operation resources to be added to the subsequent unit period in a range not exceeding the average number of addable resources in a case where the arithmetic operation resource is insufficient in each unit period after the calculation of the average number of addable resources.

4. The resource management apparatus according to claim 2,
wherein the processor calculates the number of arithmetic operation resources to be added within a range of the upper limit of the total number regardless of the average number of addable resources in a last unit period of the execution period.

5. The resource management apparatus according to claim 1,
wherein the arithmetic operation resource executes a job for which the upper limit of the total number is not permitted or a job for which the upper limit of the total number is permitted, and
the processor
calculates the number of arithmetic operation resources to be added to the unit period within a range not exceeding the upper limit of the total number, in a case where the arithmetic operation resource is insufficient when the job for which the upper limit of the total number is not permitted is executed in any one of the unit periods, and
calculates the number of arithmetic operation resources to be added not to cause insufficiency of the arithmetic operation resource in the unit period, regardless of the upper limit of the total number, in a case where the arithmetic operation resource is insufficient when the job for which the upper limit of the total number is permitted is executed in any one of the unit periods.

6. The resource management apparatus according to claim 5,
wherein the processor calculates the number of arithmetic operation resources to be added to each of the unit periods within a range not exceeding an average number of addable resources, the average number of addable resources being obtained by dividing the upper limit of the total number by the number of the unit periods included in the execution period, in a case where the arithmetic operation resource is insufficient when the job for which the upper limit of the total number is not permitted is executed in any one of the unit periods.

7. The resource management apparatus according to claim 5,
wherein the processor
calculates an average number of addable resources which is an average of the number of the arithmetic operation resources addable to a subsequent unit period within a range not exceeding the upper limit of the total number, every time the arithmetic operation resource is added to any one of the unit periods in which the job for which the upper limit of the total number is not permitted is executed, and
calculates the number of arithmetic operation resources to be added to the subsequent unit period in a range not exceeding the average number of addable resources in a case where the arithmetic operation resource is insufficient when the job for which the upper limit of the total number is not permitted is executed, in each unit period after the calculation of the average number of addable resources.

8. The resource management apparatus according to claim 1,
wherein the processor instructs the resource count control unit to reduce the added arithmetic operation resource at each switching of the unit periods within a range in which the arithmetic operation resource is not insufficient, and stops use of the instructed number of the arithmetic operation resources.

9. The resource management apparatus according to claim 1, wherein the processor:
predicts a next start time and a use resource amount of a job having periodicity;
calculates the number of arithmetic operation resources which are addable for each of the unit periods; and
sets, based on the next start time and the predicted use resource amount, the number of arithmetic operation resources which are addable to the unit period in which execution of the job having periodicity is predicted to be larger than the number of arithmetic operation resources which are addable to the unit period in which execution of the job having periodicity is not predicted.

10. The resource management apparatus according to claim 9,
wherein the processor
calculates, every time the arithmetic operation resource is added to any one of the unit periods, the number of arithmetic operation resources which are addable to a subsequent unit period in which execution of the job having periodicity is predicted and the number of arithmetic operation resources which are addable to the subsequent unit period in which execution of the job having periodicity is not predicted.

11. The resource management apparatus according to claim 9,
wherein the processor records first history information including a start time and a use resource amount every time each job is ended, and
detects a job having periodicity based on the first history information a plurality of times for each job.

12. The resource management apparatus according to claim 9,
wherein the processor
records first history information including a start time every time each job is ended,
detects a job having periodicity based on the first history information a plurality of times for each job,
records second history information including an elapsed time and a use resource amount at a predetermined frequency during execution of each job,
calculates, based on the first history information and the second history information recorded by the period prediction control unit, a maximum value of the use resource amount for each unit period in which execution of the job having periodicity is predicted, and
calculates the number of arithmetic operation resources which are addable for each unit period in which execution of the job having periodicity is predicted, based on the calculated maximum value of the use resource amount.

13. The resource management apparatus according to claim 12,
wherein the processor generates, for each job, third history information including an average value of the use resource amounts at each elapsed time based on the second history information for a plurality of periods, and
calculates, by referring to the third history information instead of the second history information, the maximum value of the use resource amount for each unit period in which execution of the job having periodicity is predicted.

14. A non-transitory computer-readable recording medium recording a resource management program for adding an arithmetic operation resource to each of a plurality of unit periods included in an execution period for executing a job causing a computer to execute a processing, the processing comprising of:
calculating, in a case where the arithmetic operation resource is insufficient in each of the unit periods, the number of arithmetic operation resources which is the number of the arithmetic operation resources to be added in the unit period within a range not exceeding an upper limit of a total number of the arithmetic operation resources which are addable to each of the plurality of unit periods; and
adding the number of arithmetic operation resources calculated by the resource count calculation unit to the unit period.

15. The non-transitory computer-readable recording medium according to claim 14, further comprising:
calculating, in a case where the arithmetic operation resource is insufficient in each of the unit periods, the processor, the number of arithmetic operation resources to be added to each of the unit periods within a range not exceeding an average number of addable resources obtained by dividing the upper limit of the total number by the number of the unit periods included in the execution period.

16. The non-transitory computer-readable recording medium according to claim 14, further comprising:
calculating an average number of addable resources which is an average of the number of the arithmetic operation resources addable to a subsequent unit period within a range not exceeding the upper limit of the total number, every time the arithmetic operation resource is added to any one of the unit periods, and
calculating the number of arithmetic operation resources to be added to the subsequent unit period in a range not exceeding the average number of addable resources in a case where the arithmetic operation resource is insufficient in each unit period after the calculation of the average number of addable resources.

17. The non-transitory computer-readable recording medium according to claim 14,
wherein the arithmetic operation resource executes a job for which the upper limit of the total number is not permitted or a job for which the upper limit of the total number is permitted, and the processing further includes:
calculating the number of arithmetic operation resources to be added to the unit period within a range not exceeding the upper limit of the total number, in a case where the arithmetic operation resource is insufficient when the job for which the upper limit of the total number is not permitted is executed in any one of the unit periods, and
calculating the number of arithmetic operation resources to be added not to cause insufficiency of the arithmetic operation resource in the unit period, regardless of the upper limit of the total number, in a case where the arithmetic operation resource is insufficient when the job for which the upper limit of the total number is permitted is executed in any one of the unit periods.

18. The non-transitory computer-readable recording medium according to claim 14, further comprising:
predicting a next start time and a use resource amount of a job having periodicity;
calculating the number of arithmetic operation resources which are addable for each of the unit periods; and
setting, based on the next start time and the predicted use resource amount, the number of arithmetic operation resources which are addable to the unit period in which execution of the job having periodicity is predicted to be larger than the number of arithmetic operation resources which are addable to the unit period in which execution of the job having periodicity is not predicted.
